(19) United States
(12) Patent Application Publication
(10) Pub. No.: US 2025/0139618 A1
(43) Pub. Date: May 1, 2025

(54) A COMPUTER IMPLEMENTED METHOD AND SYSTEM

(71) Applicant: nChain Licensing AG, Zug (CH)

(72) Inventors: Andrew James MEE, London (GB); Ricky Charles RAND, London (GB); Paul CLARK, London (GB); Alex WOODS, London (GB); Jack Owen DAVIES, London (GB); Wei ZHANG, London (GB)

(21) Appl. No.: 18/706,075

(22) PCT Filed: Sep. 1, 2022
(86) PCT No.: PCT/EP2022/074396

§ 371 Date: Apr. 30, 2024

(30) Foreign Application Priority Data
Sep. 2, 2021 (GB) 2112503.4
Mar. 25, 2022 (GB) 2204293.1
May 6, 2022 (GB) 2206682.3

(51) Int. Cl. G06Q 20/38

(52) U.S. Cl. CPC G06Q 20/389

(57) ABSTRACT

A computer-implemented method for tracking, on a blockchain, at least two clients interacting with an asset, wherein the blockchain comprises a set of transactions associated with the asset, and a set of transactions associated with each client. The asset tracking comprising receiving an asset interaction event request comprising data based on at least two clients associated with an asset interaction event and data indicative of the asset, generating an event transaction based on a reference to the set of transactions associated with the asset and references to the sets of transactions associated with the at least two clients, and submitting the event transaction to the blockchain.

### CROSS REFERENCE TO RELATED APPLICATIONS

This application is the U.S. National Stage of International Application No. PCT/EP2022/074396 filed on Sep. 1, 2022, which claims the benefit of United Kingdom Patent Application No. 2112503.4 filed on Sep. 2, 2021, United Kingdom Patent Application No. 2204293.1 filed on Mar. 25, 2022, and United Kingdom Patent Application No. 2206682.3 filed on May 6, 2022, the contents of which are incorporated herein by reference in their entireties.

### FIELD

The present disclosure relates to methods and systems for implementing a platform of one or more services associated with a distributed ledger, i.e. a blockchain for multiple users and owners. More particularly, the present disclosure provides, but is not limited to, the provision of asset and event management of assets associated with a blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks up until one or more coinbase transactions. Coinbase transactions are discussed below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at a node, and the publication of blocks can be achieved through the publication of mere block headers.

The transactions in the blockchain are used to perform one or more of the following: to convey a digital asset (i.e. a number of digital tokens), to order a set of journal entries in a virtualised ledger or registry, to receive and process timestamp entries, and/or to time-order index pointers. A blockchain can also be exploited in order to layer additional functionality on top of the blockchain. Blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in detail below. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”) or as an “output”. The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY OF THE INVENTION

According to a first aspect a computer-implemented method for tracking ownership and usage of an asset on a blockchain, comprising the steps receiving a creation request to associate an asset with a first owner on the blockchain, receiving at least one usage message comprising data indicative of a user using the asset, and upon reception of each usage message: submitting a usage transaction to the blockchain, the usage transaction comprising data based on the asset used and a user using the asset; receiving an ownership update request comprising information indicative of a second owner, and upon reception of the ownership update request: submitting an update transaction to the blockchain, the update transaction comprising information based on the asset, the first owner, and the second owner.

According to a second aspect, the present disclosure provides a device configured to perform the method of the first aspect and a system, the system comprising the server configured to perform the method of the first aspect, and a first ownership device and a second ownership device configured to coordinate transmission of an update message to the server.

In accordance with the third aspect, the present disclosure provides a computer-implemented method for tracking, on a blockchain, at least two clients interacting with an asset, wherein the blockchain comprises a set of transactions associated with the asset, a first set of transactions associated with a first client of the at least two clients, and a second set of transactions associated with a second client of the at least two client, the method comprising the steps receiving an asset interaction event request comprising data indicative of at least two clients associated with the asset interaction event and data indicative of the asset, generating an event transaction based on: at least one the reference to the set of transactions associated with the asset; at least one reference to the set of transactions associated with the first client; and at least one reference to the set of transactions associated with the second client, and submitting the event transaction to the blockchain.

In accordance with the fourth aspect, the present disclosure provides a device configured to perform the method of the third aspect and a system, the system comprising the server configured to perform the method of the third aspect, a first client device and a second client device configured to coordinate transmission of the asset interaction event request to the server.

In accordance with the fifth aspect, the present disclosure provides a computer-implemented method for tracking events of an asset on a blockchain, comprising the steps receiving a creation request to create a set of transactions associated with the asset, generating and submitting to the blockchain a first ownership transaction associated with a set of transactions associated with the asset and associated with a set of transactions that is associated with a first owner, receiving an ownership update request comprising information indicative of a second owner, and upon reception of the ownership update request: generating and submitting an update transaction to the blockchain, the update transaction comprising information indicative of the asset, the first owner, and the second owner.

In accordance with the sixth aspect, the present disclosure provides a device configured to perform the method of the fifth aspect and a system, the system comprising the server configured to perform the method of the fifth aspect, a first owner device and a second client device configured to coordinate transmission of the ownership update request to the server.

Some specific components and embodiments of the disclosed method are now described by way of illustration with reference to the accompanying drawings, in which like reference numerals refer to like features.

### BRIEF DESCRIPTION OF THE FIGURES

FIG. 1 depicts an example system for implementing a blockchain.

FIG. 2 illustrates an example transaction protocol.

FIGS. 3A and 3B illustrate an example implementation of the client application and its user interface.

FIG. 4 illustrates an example of the node software that is run on each blockchain node of the network.

FIG. 5 is a schematic diagram illustrating interactions between a platform processor, blockchain network, and clients.

FIGS. 6A-6C illustrate example methods for recording events and interactions with an asset.

FIG. 7 illustrates a schematic diagram showing example sets of transactions and the transactions that are comprised in them.

FIG. 8 illustrates an example transaction format.

FIG. 9 illustrates an example transaction format for a transaction that is associated with multiple sets of transactions.

FIG. 10A-D illustrates an example data format and transaction formats associated with said example data format.

FIG. 11 is a schematic diagram, depicting an overview of a platform for a plurality of services associated with a blockchain, according to an aspect.

FIG. 12 is a schematic diagram, depicting the components of the platform of a plurality of services that are associated with a blockchain, according to an aspect.

FIG. 13 is a schematic diagram, illustrating a computing environment in which various aspects and embodiments of the present disclosure can be implemented.

### DETAILED DESCRIPTION

Accordingly, there is a desire to implement secure, low-complexity, user-friendly, efficient, and robust techniques, that will allow any client, whether computationally sophisticated or not, to be able to instantaneously access and interact with useful applications associated with the blockchain, in a simple, fast, accurate, reliable, and secure manner, that is computationally and functionally less onerous. More particularly, there is a desire to provide secure, simple, fast, accurate, and synchronised tracking of events (and other technical and real-world interactions), including usage and ownership transfer, associated with an asset.

Such an improved solution has now been devised. The present disclosure addresses the above technical concerns by proposing one or more techniques whereby real-world events and interactions with an asset across multiple users and clients may be simply, securely, in-order, and/or instantaneously recorded, or obtained from the blockchain by said clients that have stake or interest in said asset. Methods, devices, and systems which provide an application programming interface (API) for one or more services associated with a blockchain, without such clients needing to implement any processing or functionality for using the blockchain, nor any processing or functionality for user management, while still being able to avail all advantages associated with the blockchain.

In accordance with the first aspect, the present disclosure provides a computer-implemented method for tracking ownership and usage of an asset on a blockchain, comprising the steps receiving a creation request to associate an asset with a first owner on the blockchain, receiving at least one usage message comprising data indicative of a user using the asset, and upon reception of each usage message: submitting a usage transaction to the blockchain, the usage transaction comprising data based on the asset used and a user using the asset; receiving an ownership update request comprising information indicative of a second owner, and upon reception of the ownership update request: submitting an update transaction to the blockchain, the update transaction comprising information based on the asset, the first owner, and the second owner.

Advantageously, the use of the blockchain and blockchain transactions provides immutability, security, and auditability to the present and any associated aspects. This is of particular importance as it provides technical features that enable users of the present aspect to establish and/or maintain/update a tamper-proof record or log, or a certificate confirming the sequential occurrence of events where an event in the present aspect is the use and/or transfer of ownership of an asset.

Optionally, the blockchain comprises any one or more of the following: a set of transaction associated with the asset, a set of transactions associated with the user, a set of transactions associated with the first owner, and a set of transactions associated with the second owner.

Advantageously, the sets of transactions provide blockchain based data representations of each of the asset, owners, and users. This further enables any parties associated with the present aspect (i.e. auditors, owners, users, or others) to efficiently and easily sort, append, search, or conduct any data related actions related to the asset, owners, users, etc. As presented throughout, these data related actions are used when auditing or interacting with the asset such as transferring ownership. Also as discussed herein, the sorting of events is maintained as a result of the technical features of the blockchain, in particular through the use of the chain of dust spending relationship. Also as a result of the chain of dust spending relationships, any append actions are automatically recorded in-order on the blockchain.

Optionally, the set of transactions associated with the asset is associated with a smart contract associated with the asset, the set of transactions associated with the first owner is associated with a smart contract associated with the first owner, the set of transactions associated with the second user is associated with a smart contract associated with the second user, and the set of transactions associated with the user is associated with a smart contract associated with the user.

Optionally, the set of transactions associated with the asset pertains to an event stream associated with the asset, the set of transactions associated with the user pertains to an event stream associated with the user, the set of transactions associated with the first owner pertains to an event stream associated with the first owner, and the set of transactions associated with the second owner pertains to an event stream associated with the second owner. Preferably, each event stream represents a smart contract such that the event stream tracks a sequence of events associated with a smart contract.

Advantageously, the present aspect enables establishing and/or maintaining/updating a tamper-proof record or log, or a certificate confirming the sequential occurrence of events associated with an event stream, where the events are based on received client inputs for a given smart contract, for the execution of the smart contract. Thus, the present embodiment proposes methods, devices, and systems for enabling processing, i.e. creating, updating and/or terminating event stream ES, that is implemented using the blockchain and automatically creates a tamper-proof log or record of events associated with the smart contract SC that is pertaining to the event stream ES.

Optionally, the usage transaction comprises a first data payload comprising data based on at least one reference to the set of transactions associated with the asset and a second data payload comprising data based on at least one reference to a transaction from the set of transactions associated with the user. Preferably, each of the first and second data payloads are based on a first and a second reference. More preferably, the first reference is a reference to a next transaction and the second reference is a reference to a previous transaction in the set of transactions. Even more preferably, the second reference is a reference comprising data stored on the previous transaction and the first reference is an outpoint that the next transaction spends (or will spend). Most preferably, each data payload is a Merkle tree root.

Optionally, the set of transactions associated with the asset comprises, indicates, or is based on ownership history of the asset.

Optionally, the update transaction comprises a third data payload comprising data based on a third reference to a transaction from the set of transactions associated with the asset, a fourth data payload comprising data based on a fourth reference to a transaction from the set of transactions associated with the first owner, and a fifth data payload comprising data based on a fifth reference to a transaction from the set of transactions associated with the second owner. Preferably, upon confirmation of the update transaction to the blockchain, ownership of the asset is considered transferred from the first owner to the second owner.

Optionally each of the third, fourth, and fifth payloads are based on two references to transactions in their respective sets of transactions. Preferably, the two references are a previous transaction reference and a next transaction reference. Even more preferably, the previous transaction reference is a reference comprising data stored on the previous transaction and the next transaction reference is an outpoint that the next transaction spends (or will spend). More preferably, each payload is a Merkle tree root.

Optionally, the present aspect further comprises the steps of receiving a history request from a requestor comprising a reference to the asset, and in response to reception the history request: providing a history of uses of the asset to the requestor, wherein the history of the uses of the asset comprises information from the set of transactions associated with the asset and/or is verified using information from the set of transactions associated with the asset.

Advantageously, through use of a Merkle tree root and a Merkle tree proof, asset history is verifiable while also being selectively disclosable allowing for finer grained secure control of data.

Optionally, the usage message comprises data indicative of usage of the asset by a user and the usage transaction comprises data indicative of or based on usage of the asset. Advantageously, this provides technical features to enable a person to audit and confirm their usage.

Optionally, the asset is a pay-per-use non-fungible good, product, or service. Preferably the asset is a song, and the data indicative of usage comprises the number of times and/or length of time a user has listened to said song.

In accordance with the second aspect, the present disclosure provides a device configured to perform the method of the first aspect and a system, the system comprising the server configured to perform the method of the first aspect, and a first ownership device and a second ownership device configured to coordinate transmission of an update message to the server.

In accordance with the third aspect, the present disclosure provides a computer-implemented method for tracking, on a blockchain, at least two clients interacting with an asset, wherein the blockchain comprises a set of transactions associated with the asset, a first set of transactions associated with each a first client of the at least two clients, and a second set of transactions associated with a second client of the at least two clients, the method comprising the steps: receiving an asset interaction event request comprising data indicative of at least two clients associated with an asset interaction event and data indicative of the asset, generating an event transaction comprising data based on: at least one reference to the set of transactions associated with the asset; and at least one references to the sets of transactions associated with the at least two clients the first client; and at least one reference to the set of transactions associated with the second client, and submitting the event transaction to the blockchain.

Optionally, further comprising the steps: obtaining a reference to the set of transactions associated with the asset, and obtaining references to each set of transactions associated with the clients associated with the asset interaction event.

Optionally, a first reference of the at least one reference to the set of transactions associated with the asset comprises or is an asset transaction outpoint associated with the set of transactions associated with the asset. Preferably, the asset transaction outpoint points towards a next transaction in the set of transactions associated with the asset.

Optionally, a second reference of the at least one reference to the set of transactions associated with the asset comprises data stored on the latest transaction in the set of transactions associated with the asset. Preferably, the second reference of the at least one reference to the set of transactions associated with the asset is part of the data payload stored of the latest transactions in the set of transactions associated with the asset.

Advantageously, storing two references based on different properties of the blockchain transactions (namely transaction outpoints and data stored on a transaction output) increases security of the set of transactions.

Optionally, each of the references to the sets of transactions associated with the at least two clients comprises a transaction outpoint associated with each of the set of transactions associated with the at least two clients. Preferably, each transaction outpoint points towards a latest transaction in each respective set of transactions associated with the clients.

Optionally, once the event transaction has been confirmed on the blockchain, the event transaction is considered part of the set of transactions associated with the asset and each of the sets of transactions associated with the at least two clients.

Optionally, the set of transactions associated with the asset pertains to an event stream associated with the asset and each set of transactions associated with a given client among the at least two clients pertains to an event stream associated with said given client. That is to say, the set of transactions associated with the first client of the at least two clients pertains to an event stream associated with the first client and the set of transactions associated with the second client of the at least two clients pertains to an event stream associated with the second client. Preferably, each event stream represents a respective smart contract such that the event stream tracks a sequence of events associated with the smart contract. Optionally, each set of transactions represents a respective smart contract. Alternatively, there is one smart contract that is associated with all of the event streams in the present embodiment. The one smart contract updates multiple event streams.

Optionally, the event transaction comprises data based on the asset interaction event. Preferably, the data based on the asset interaction event is stored on an unspendable output of the event transaction. More preferably, the unspendable output comprises an OP_RETURN opcode.

Optionally, the asset is a pay-per-use non-fungible good, product, or service. Preferably, the asset is a song and/or the asset interaction event is to exchange ownership of the asset between the at least two clients.

Optionally, the method further comprises the steps of: receiving a creation request to create a set of transactions associated with the asset, and generating and submitting to the blockchain a first ownership transaction associated with the set of transactions associated with the asset and associated with a set of transactions that is associated with a first client of the at least two clients. Preferably, the first ownership transaction comprises data based on a digital fingerprint uniquely identifying the asset.

Optionally, the event transaction comprises a payload for each set of transactions the event transaction belongs to. Preferably, the event transaction comprises a first payload associated with the set of transactions associated with the asset, a second payload associated with the set of transactions associated with the first client, and a third payload associated with the set of transactions associated with the second client. More preferably, the first payload is based on the at least one reference to the set of transactions associated with the asset, the second payload is based on the at least one reference to the set of transactions associated with the first client, and the third payload is based on the at least one reference to the set of transactions associated with the second client. Optionally, the first, second, and third payloads are Merkle tree roots and the method further comprises the step of generating each Merkle tree and calculating the Merkle tree root. Optionally, the payloads are each stored on outputs of the event transaction.

Optionally, the method further comprises the step of generating a data payload based on data indicative of at least two clients associated with the asset interaction event and data indicative of the asset. Preferably, the data payload is a Merkle tree root. More preferably, the step of generating the data payload comprises generating a Merkle tree comprising data indicative of at least two clients associated with the asset interaction event and data indicative of the asset. Even more preferably, the data payload is stored on an output of the event transaction.

Optionally, the asset interaction event is an ownership update request that comprises information indicating transfer of ownership of the asset from the first of the at least two clients to the second of the at least two clients. Preferably, the event transaction comprises data based on the first client transferring ownership to the second client.

In accordance with the fourth aspect, the present disclosure provides a device configured to perform the method of the third aspect and a system, the system comprising the server configured to perform the method of the third aspect, a first client device and a second client device configured to coordinate transmission of the asset interaction event request to the server.

A person skilled in the art will appreciate that a number of the embodiments according to these third and fourth aspects provide the same or similar advantages as described with reference to the first and/or second aspects.

In accordance with the fifth aspect or alternatively, as a further embodiment of the third aspect, the present disclosure provides a computer-implemented method for tracking events of an asset on a blockchain, comprising the steps receiving a creation request to create a set of transactions associated with the asset, generating and submitting to the blockchain a first ownership transaction associated with a set of transactions associated with the asset and associated with a set of transactions that is associated with a first owner, receiving an ownership update request comprising information indicative of a second owner, and upon reception of the ownership update request: generating and submitting an update transaction to the blockchain, the update transaction comprising data based on the asset, the first owner, and the second owner.

Optionally, where the above is presented as an embodiment of the third aspect, each of the owners here can be considered analogous to each of the clients in the preceding aspects.

Optionally, the data based on the asset is a reference to the set of transactions associated with the asset, the data based on the first owner is a reference to the set of transactions associated with the first owner, and the data based on the second owner is a reference to the set of transactions associated with the second owner. Preferably, the reference is based on data stored on a previous transaction in the same set of transactions and/or based on a transaction outpoint funding a transaction which is part of the same set of transactions.

Optionally, the reference to the sets of transactions comprises or is an outpoint referring to a transaction in the set of transactions. Preferably, the outpoint refers to the next transaction in each set of transactions. That is to say, preferably, the reference to the set of transactions associated with the asset comprises or is an outpoint of a transaction in the set of transactions associated with the asset, the reference to the set of transactions associated with the first owner comprises or is an outpoint of a transaction in the set of transactions associated with the first owner, and the reference to the set of transactions associated with the second owner comprises or is an outpoint of a transaction in the set of transactions associated with the second owner.

Optionally, the set of transactions associated with the asset pertains to an event stream associated with the asset, the set of transactions associated with the first owner pertains to an event stream associated with the first owner, and the set of transactions associated with the second owner pertains to an event stream associated with the second owner.

Optionally, each event stream represents a respective smart contract such that the event stream tracks a sequence of events associated with said respective smart contract. Alternatively, there is one smart contract that is associated with all of the event streams in the present embodiment. The one smart contract updates multiple event streams.

Optionally, the initial transaction comprises data based on a digital fingerprint uniquely identifying the asset.

Optionally, the update transaction comprises data based on the first owner transferring ownership to the second owner. Preferably, the data based on the ownership transfer is stored on an unspendable output of the update transaction. More preferably, the unspendable output comprises an OP_RETURN opcode. Optionally the unspendable output additionally comprises an OP_0 opcode.

Optionally, the asset is a pay-per-use non-fungible good, product, or service. Preferably the asset is a song.

In accordance with the sixth aspect, the present disclosure provides a device configured to perform the method of the fifth aspect and a system, the system comprising the server configured to perform the method of the fifth aspect, a first owner device and a second client device configured to coordinate transmission of the ownership update request to the server.

A person skilled in the art will appreciate that a number of the embodiments according to this fourth aspect provide the same or similar advantages as described with reference to the first, second, and/or third aspects.

According to a further aspect, there is provided a device configured to perform the methods of any of the preceding aspects.

Advantageously, using the above-described aspects, a first owner is able to track events associated with the asset they own. The tracking is secure, immutable, and known to be in-order with respect to other events occurring. As described herein, events can relate to real world usage of the asset. Tracking events relating to interactions with and/or condition of the asset are of particular interest to the owner/owner's device as it may trigger further necessary repair and, because the sequence of the events (including the last user to use the asset), appropriately associate any required repairs with the user that may have caused such changes in condition.

Where the asset is a pay-per-use non-fungible good, product, or service, the present aspects provide advantages to track usage, ownership, or any other kind of interaction of the asset as well as any other effects associated with interactions such as deterioration of the asset and/or depreciation of the asset. The technical features of the embodiments to track these real-world interactions enable a more streamlined, instant, and secure tracking system.

Advantageously, the use of sets of transactions can provide privacy preserving read access to the event data that has been stored on the blockchain. A potential owner or other auditor wishing to inspect the event history of an asset being tracked on the blockchain has the ability to view only the set of transaction associated with the asset over its lifetime. Similarly, a user of an asset can audit their own usage of different assets by traversing only their set of transactions and/or through use of provided Merkle proofs and verification against the on-chain stored Merkle tree roots. Optionally, such privacy features can come from encrypting the event data before submission to the blockchain, and/or storing a proof of existence on the blockchain, while keeping the event data itself off-chain and not publicly readable. When required, the data can be provided for an auditor to confirm that the proof of existence stored on the blockchain is in coordination with the actual data (such as through use of Merkle tree proofs).

In an embodiment of any of the preceding aspects, a device (operated by for example a potential purchaser of an asset) can transmit an asset history request. Upon reception of such a request, data about the usage of the asset is provided to the requestor. Preferably the data about the usage is obtained by traversing and/or accessing the set of transactions associated with the asset. Preferably, the data about the usage is verified using the set of transactions associated with the asset.

### Example System Overview

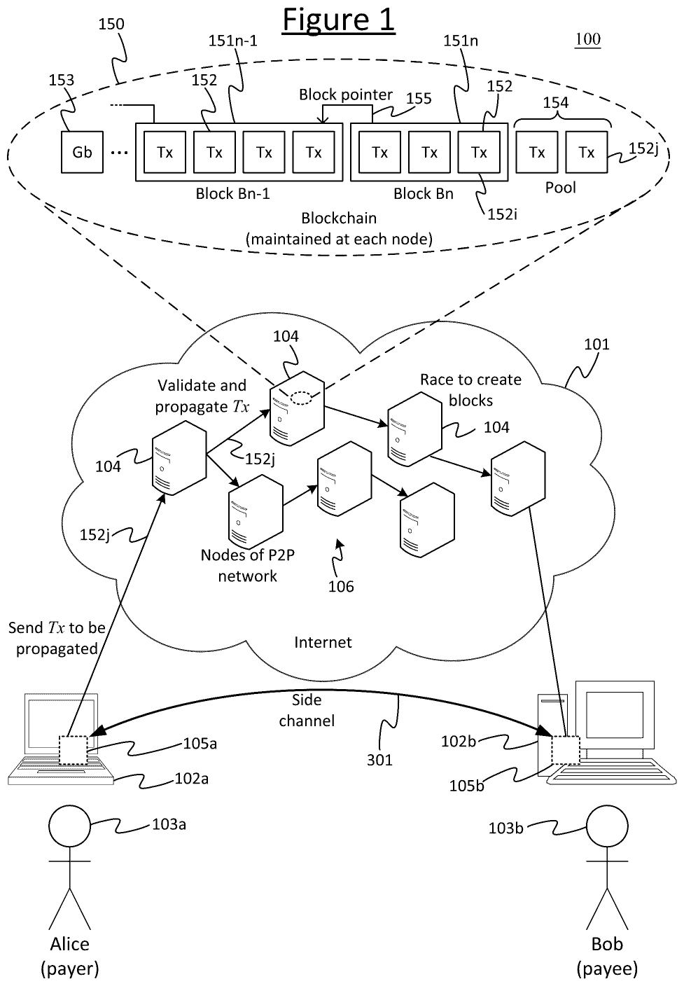

FIG. 1 shows an example system 100 for implementing a blockchain 150. The system 100 may comprise of a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as Application Specific Integrated Circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 160. As mentioned above, maintaining a copy of the blockchain 150 does not necessarily mean storing the blockchain 150 in full. Instead, the blockchain 150 may be pruned of data so long as each blockchain node 150 stores the blockheader (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions. Optionally, the inputs refer to transaction outpoints, where an outpoint is the transaction id and the index of the output being referenced.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set 154 of transactions 152 waiting to be incorporated into blocks 151. The ordered set 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions and redistribute to one or more outputs of the current transaction.

According to an output-based transaction protocol such as bitcoin, when an entity, such as a user or machine, 103 wishes to enact a new transaction 152j, then the entity sends the new transaction from its computer terminal 102 to a recipient. The entity or the recipient will eventually send this transaction to one or more of the blockchain nodes 104 of the network 106 (which nowadays are typically servers or data centres but could in principle be other user terminals). It is also not excluded that the entity 103 enacting the new transaction 152j could send the transaction to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the entity 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned is whether it has yet been validly redeemed by the input of another, onward transaction 152j according to the blockchain node protocol. Another condition for a transaction to be valid is that the output of the preceding transaction 152i which it attempts to assign or redeem has not already been assigned/redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered set 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered set of transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. A significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the ordered set of yet to be published transactions 154 at any given time, depending on when they started searching for a solution or the order in which the transactions were received. Whoever solves their respective puzzle first defines which transactions 152 are included in the next new block 151n and in which order, and the current set 154 of unpublished transactions is updated. The blockchain nodes 104 then continue to race to create a block from the newly defined outstanding ordered set of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to assign an accepted amount of the digital asset in a new special kind of transaction which distributes a defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network but do not participate in validating, constructing or propagating transactions and blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered set of transactions 154 maintained at a given blockchain node 104, that blockchain node 104 will start competing to solve the proof-of-work puzzle on the latest version of their respective ordered set of transactions 154 including the new transaction 152 (recall that other blockchain nodes 104 may be trying to solve the puzzle based on a different ordered set of transactions 154, but whoever gets there first will define the ordered set of transactions that are included in the latest block 151. Eventually a blockchain node 104 will solve the puzzle for a part of the ordered set 154 which includes Alice's transaction 152j). Once the proof-of-work has been done for the ordered set 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

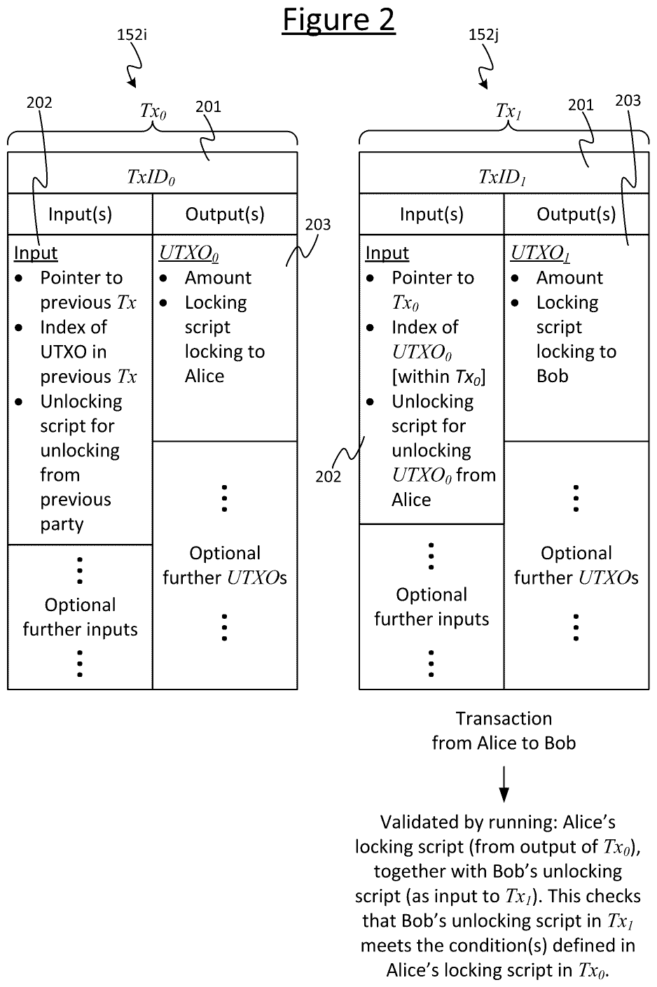

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language).

More preferably, “< . . . >” refers to PUSHDATA encoded data. Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered set of transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node that publishes her transaction 104. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that publishes the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150.

E.g. the data could comprise a document which it is desired to store in the blockchain. Using OP_RETURN in this manner is a specific example using a provably unspendable script for use on a Bitcoin based blockchain system. Optionally, OP_0 is used in addition to OP_RETURN. A person skilled in the art will appreciate that different blockchain systems will have different mechanisms and data formats for ensuring scripts are unspendable and/or storing data in a transaction.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 301 with Bob 103b (at the instigation of either party or a third party). The side channel 301 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 301 may be used to exchange any other transaction related data, such as keys, negotiated amounts or terms, data content, etc.

The side channel 301 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

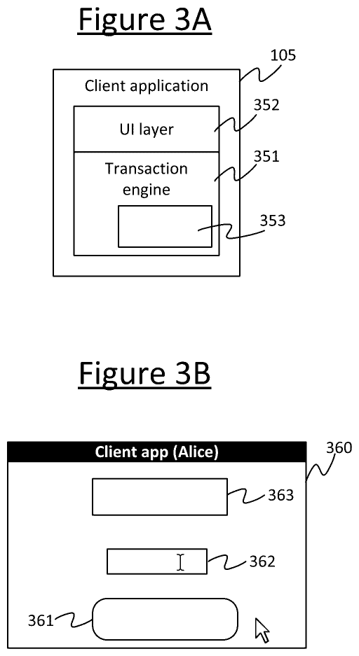

FIG. 3A illustrates an example implementation of the client application 105 for implementing embodiments of the presently disclosed scheme. The client application 105 comprises a transaction engine 351 and a user interface (UI) layer 352. The transaction engine 351 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 351 of each client 105 comprises a function 353 . . . .

The UI layer 352 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 351 may be implemented in a separate application than the UI layer 352, or the functionality of a given module such as the transaction engine 351 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 360 which may be rendered by the UI layer 352 of the client application 105a on Alice's equipment 102a. It will be appreciated that a similar UI may be rendered by the client 105b on Bob's equipment 102b, or that of any other party.

By way of illustration FIG. 3B shows the UI 360 from Alice's perspective. The UI 360 may comprise one or more UI elements 362, 362, 363 rendered as distinct UI elements via the user output means.

For example, the UI elements may comprise one or more user-selectable elements 362 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 362, through which the user can . . . . These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 363 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 360 shown in FIG. 3 is only a schematized mock-up and in practice it may comprise one or more further UI elements, which for conciseness are not illustrated.

### Node Software

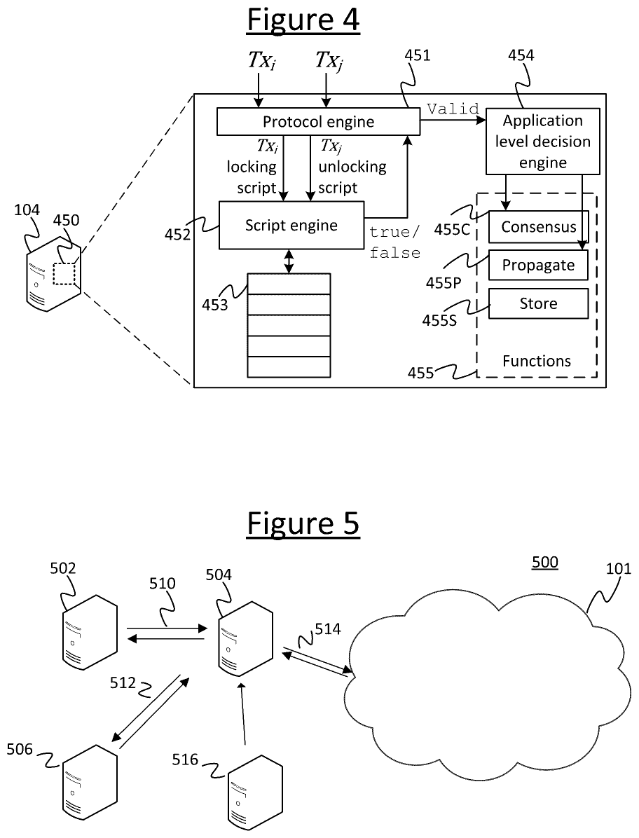

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 351 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txⱼ based on the pointer in the input of Txⱼ. Txⱼ may be published on the blockchain 150, in which case the protocol engine may retrieve Txⱼ from a copy of a block 151 of the blockchain 150 stored at the node 104. Alternatively, Txⱼ may yet to have been published on the blockchain 150. In that case, the protocol engine 451 may retrieve Txⱼ from the ordered set 154 of unpublished transactions maintained by the node 104. Either way, the script engine 451 identifies the locking script in the referenced output of Txⱼ and passes this to the script engine 452.

The script engine 452 thus has the locking script of Txⱼ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txⱼ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Tx₁ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

### Asset and Event Tracking

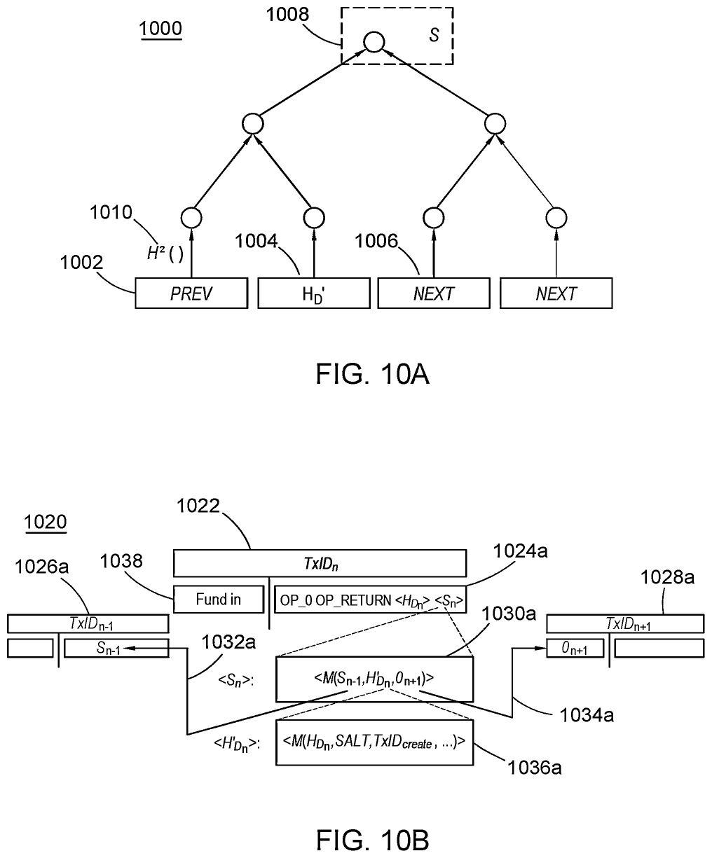

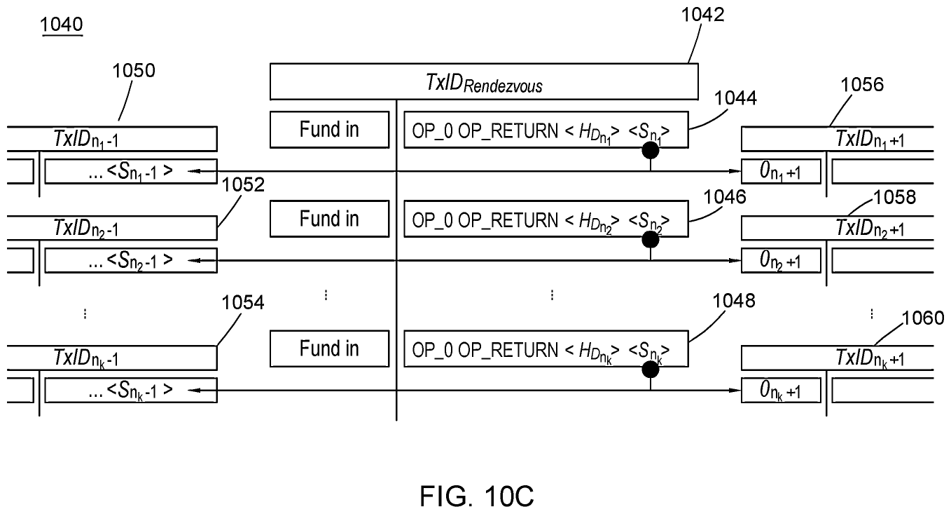

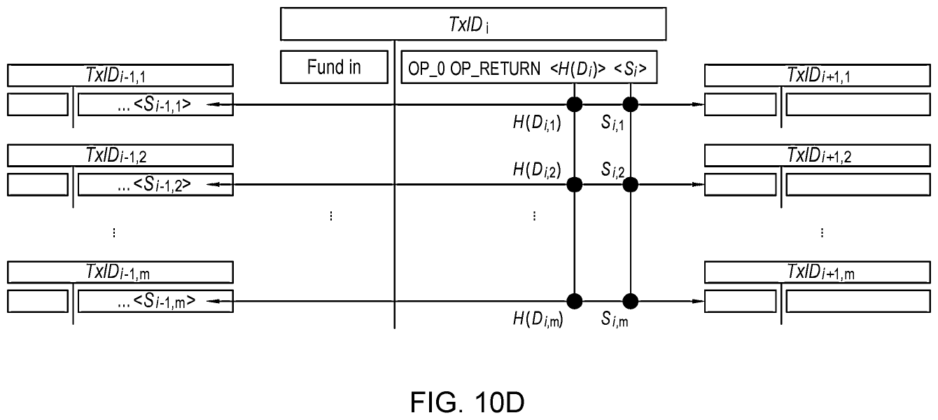

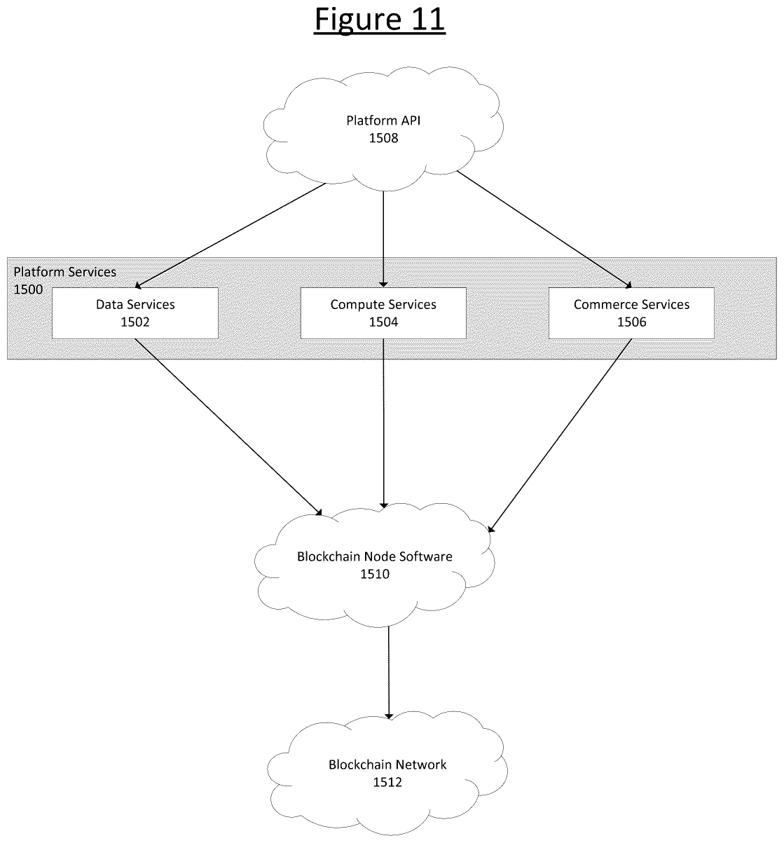

FIG. 5 relates to a system 500 according to a first aspect of the present disclosure for the provision of a blockchain based, synchronised, in-order, immutable, log of events associated with an asset 516, preferably as a part of a platform processor 504 that provides a plurality of services that are associated with a blockchain 101. Preferably an event refers to interactions with the asset including usage of the asset. The platform processor 504 is optionally the platform as described in greater detail below with respect to FIGS. 10 and 11. The platform processor 504 is configured to communicate and/or otherwise interact with the blockchain 101, an asset owner 502, an asset user 506 and/or the asset 516. The platform processor 504 is described herein as a monolithic server for ease of illustrative purposes. Where “client”, “user”, or similar terms are used, it will be understood that this may refer to a device owned and/or controlled by said client or user. A person skilled in the art will appreciate that a platform processor 504 may be implemented as a single server, a mainframe, a collection of servers, a microservice, a collection of microservices, cloud service, any combination of the preceding and/or other computing platform or platforms.

A person skilled in the art will appreciate that while this example provides for one asset to be tracked, the platform service 504 can be configured to track multiple assets with the same or different and/or multiple owners of the asset(s). Preferably there is at least one user 506 of the asset 516.

The system 500 of this example comprises a first owner 502, and a second owner (not shown in FIG. 5). The owner(s) own the asset and/or have an interest and/or stake in the usage and/or interactions made with the asset 516. Optionally, the asset 516 has multiple owners associated with it at any one time.

Preferably, each of the owner(s) 502, user(s) 506, and asset(s) 516 are configured to transmit event data to the platform processor 504 such that the platform processor can process and record the events. Preferably, the event data comprises data indicative of the event and who was involved with the event and optionally includes other metadata such as a time when the event occurred. Preferably the event data is transmitted via API requests as described below with reference to FIGS. 10 and 11. A representation of the events, or at least a subsection of the events, are recorded on the blockchain 101. Alternative to storing the event itself on the blockchain, is to store a proof of existence of said event. A proof of existence preferably would be a hash of the event data. By storing the proof of the event and not the event itself, storage space on the blockchain can be reduced, the transaction fees will likely be lower, and privacy of the event is preserved on-chain, while still maintaining all of the same advantages associated with an immutable, in-order, blockchain based log.

Optionally, the event data is processed to generate representative event data. The representative event data can be seen as being based on the event data. Thus, representative event data can include any one or more of: the unmodified event data itself, a hash of the event data, a root hash of a cryptographic structure comprising the event data, or the output of another data processing step.

The representative event data is preferably stored on the blockchain as a part of a transaction. The representative event data is held in an un-spendable OP_RETURN output of the transaction. This is a Script opcode which can be used to write arbitrary data on blockchain and also to mark a transaction output as invalid. As another example, OP_RETURN is an opcode of the Script language for creating an un-spendable output of a transaction that can store data such as metadata within the transaction, and thereby record the metadata immutably on the blockchain 101. Optionally, OP_0 is used in addition to OP_RETURN.

Preferably, the blockchain 101 comprises a set of transactions associated with each of the owner(s) 502, user(s) 506, and asset(s) 516. Each set of transactions represents or is associated with a synchronised, in-order, immutable, log of events associated with the appropriate owner, user, or asset. More preferably, the set of transactions is associated with an event stream as described below under the heading “Event Streams”. Even more preferably, the event stream is associated with a smart contract associated with the owner, user, or asset it is representing. Each transaction in the set of transactions is preferably created and submitted to the blockchain by the platform processor 504.

An event as used herein is understood to be broad rather than specific to the examples provided herein. Different owners 502, users 506, or assets 516 within the system 500 will have different types of events associated with them. For example, an event associated with the owner 502 could be any one or more of the following:
Purchasing and/or creation of an asset,
Using an asset,
Depreciation of an asset,
Selling of an asset, and
Upgrading and/or repairing an asset.

For example, an event associated with the asset 516 could be any one or more of the following:
Using the asset,
If the asset is a component in a chemical production process, a critical temperature has been reached,
A component of the asset is close to breaking or has broken,
If the asset is a car, a speed or distance has been exceeded, and
The number of times an asset has been used in a given period.

For example, an event associated with the user 506 could be any one or more of the following:
Using of an asset along with a length of time, number of times, or other usage metric,
Recording the status of an asset while in use (particularly if the asset isn't performing correctly), and
Return/relinquishment of an asset with a confirmation of the status or condition of the asset.

A person skilled in the art will appreciate that other events are possible. Where it is mentioned that the event is stored on the blockchain 101, it is preferable that the event is stored on the blockchain as representative event data as discussed above. This representative event data could be based on text describing what the event was and include any relevant variables such as a temperature, time period of use, a voltage, a cryptographic key, and more. The type and format of data stored may depend on the event. A skilled person will appreciate that different events will require different data types to represent them.

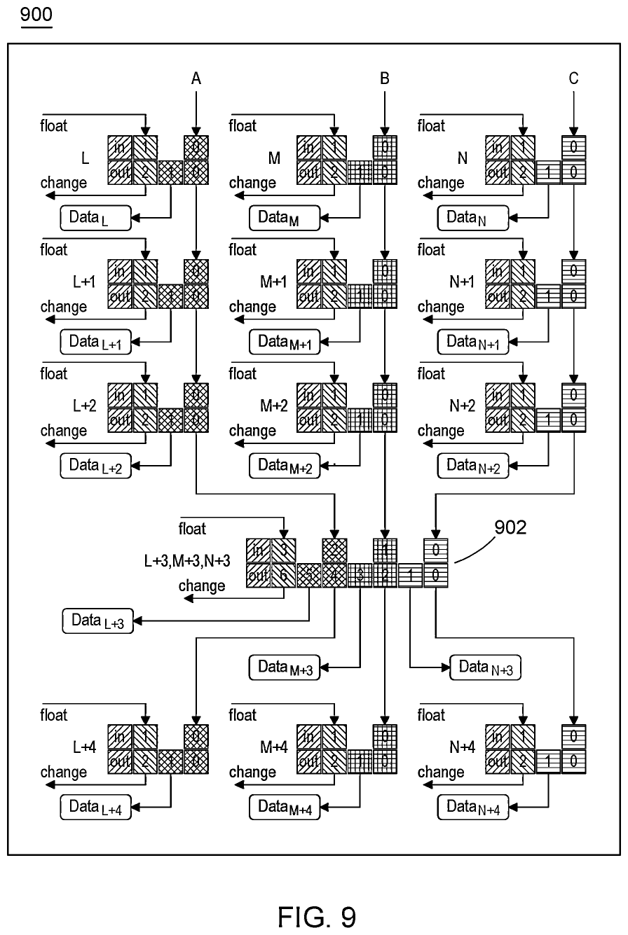

Of note, a number of these events are associated with two or more of the owners 502, users 506 and/or assets 516. In these cases, each set of transactions associated with each owner, user, or asset needs to be updated with the transaction comprising the new event. Preferably each set of transactions is updated atomically (such that not only one set of transactions get a new transaction comprising the event—either all sets or no sets receive the event) and/or synchronously (such that events that have occurred previous to this current event involving multiple owner(s), user(s), or asset(s) do not get added to the set of transactions out of order with respect to any sets of transactions). Preferably, the sets of transactions are updated both atomically and synchronously with respect to other events. Preferably, each set of transactions relevant to the event are updated atomically through use of a single transaction that belongs to all of the sets of transactions associated with the owner(s), user(s), or asset(s) associated with the event. For example, if an asset were sold by a first owner to a second owner, a single transaction will belong to all of: (i) the set of transaction associated with the asset, (ii) the set of transactions associated with the first owner, (iii) and the set of transactions associated with the second owner. Further description below with reference to FIG. 9, 10C or 10D provide examples of how such a transaction can be associated with two or more sets of transactions.

The system 500 preferably further provides the ability for the owner(s) 502 and/or the user(s) 506 to read any event data stored by the platform processor 504. This reading of event data is preferably conducted by submitting a request to the platform processor 504. Alternatively or additionally, the data may be obtained directly from the blockchain 101.

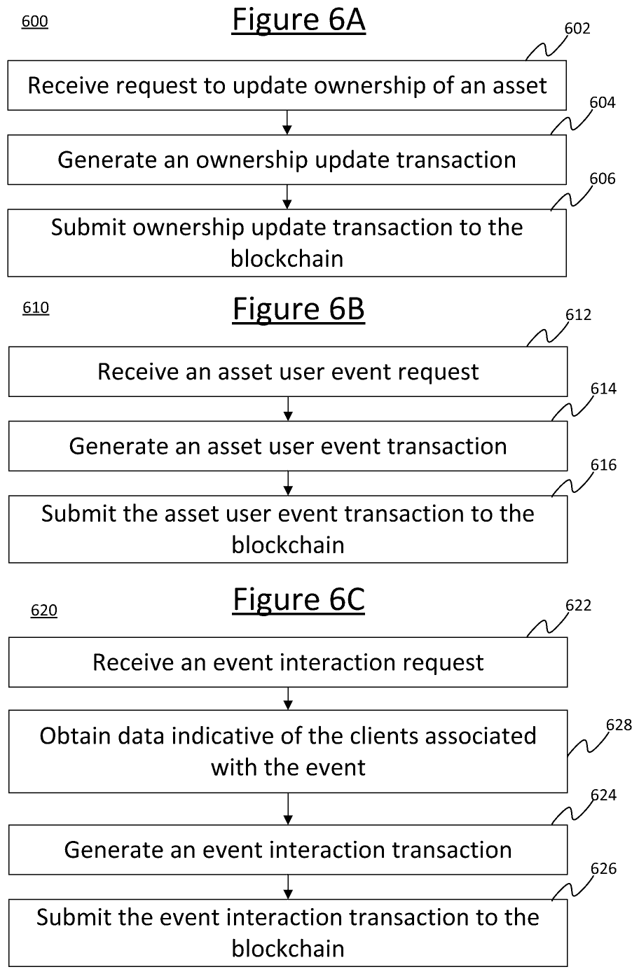

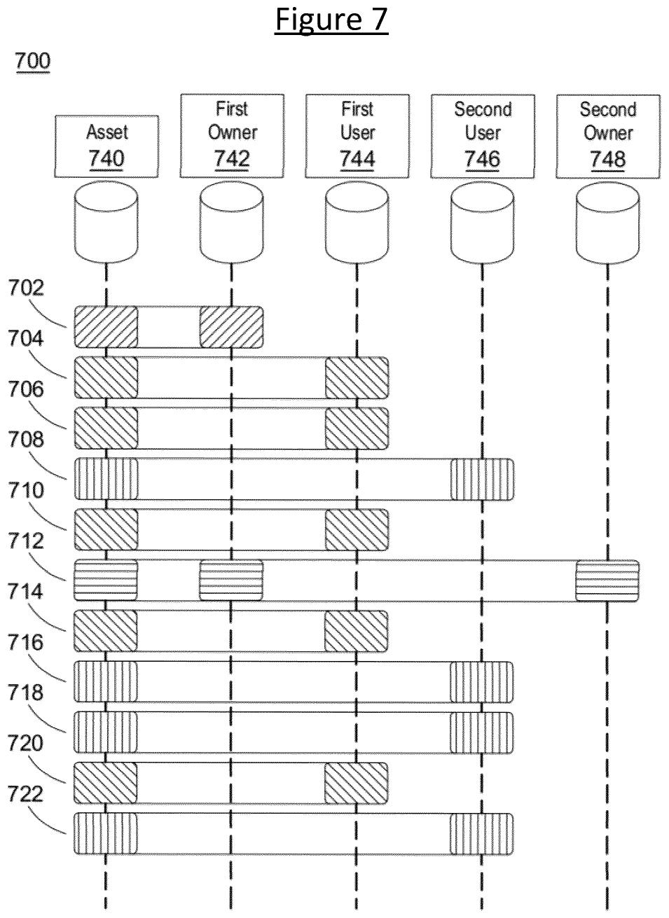

FIGS. 6A-6C illustrate example methods 600, 610, 620 where different types of events are submitted for recordal on the blockchain in a transaction. Each transaction is associated with a set of transactions associated with each of the owner(s), user(s), and/or asset(s) relevant to the event. FIG. 7 illustrates the status of the sets of transactions after a number of events have occurred. A number of transactions 702-722 are shown being associated to different sets of transactions 740-748. Each set of transactions 740-748 is depicted as a vertical line down the figure where every transaction 702-722 that comprises a block on the vertical line is a transaction that is a part of the set of transactions associated with said line.

In the present example, sets of transactions 740-748 have already been established prior to this. Optionally, the set of transactions associated with the asset 740 is created in the create transaction 702. Preferably this create transaction 702 comprises information to uniquely identify the asset such as a serial number or digital certificate. Where the asset is a song, the create transaction 702 comprises a digital fingerprint to uniquely identify the song. Similarly, each other set of transactions comprise a create transaction (not shown). These would also comprise identifying information such as a user's public key and/or digital signature.

The methods 600, 610 of FIGS. 6A and 6B describe two specific types of events being recorded. Preferably, the platform processor 504 is configured to undertake both methods 600, 610. The ownership transfer method 600 provides an example where three sets of transactions are updated and the asset user event method 610 provides an example where two sets of transactions are updated. A person skilled in the art will appreciate that these are specific examples of asset-related events for submission to a blockchain and that other examples of event transactions are possible where different sets of transactions need to be synchronised.

Starting with FIG. 6A, a method 600 is shown where a transfer of ownership of an asset is recorded. The method is preferably conducted by the platform processor 504.

Prior to the method shown, a creation request was preferably received to associate the asset with the first owner. Preferably, either or both of a set of transactions associated with the asset and a set of transactions associated with first owner are also created at the same time if they are not already created. More preferably, a transaction is submitted to the blockchain that is associated with both the asset and first owner sets of transactions. An example of such a transaction can be seen in FIG. 7 as the first transaction 702.

First, a request to update the ownership of an asset is received 602. The request is preferably generated by either the first owner of the asset, or the second owner.

The request comprises data to identify the asset and information such that both the first and second owners have consented to the ownership transfer. Optionally, such data is a cryptographic signature of both of the first and second owners.

Next, an ownership update transaction is generated which is based on data indicative of the asset, the first owner, and the second owner. Preferably, the ownership update transaction belongs to a set of transactions associated with the asset 740, a set of transactions associated with the first owner 742, and a set of transactions associated with the second owner 748.

More preferably, the data indicative of the asset is used to associate the ownership update transaction with the set of transactions associated with the asset 740. This applies similarly to the data relating to the first and second owners and their respective sets of transactions 742, 748.

The ownership update transaction is submitted 606 to the blockchain.

Referring to FIG. 7, example first and second ownership update transactions 702, 712 are shown. In these transactions 702, 712 the asset is first recorded as owned by the first owner (as shown by the first ownership update transactions 702 being in both the asset set 740 and first owner set 742) and then transferred (as shown by the second ownership update transaction being all of the asset 740, first owner 742, and second owner's 748 set of transactions). The first ownership update transaction 702 represents the asset (or the set of transactions associated with the asset) being created on the blockchain. It can be seen that said transaction 702 is present in (or belongs to) both the sets of transactions associated with the asset 740 and the first owner 742. Thus both of the sets of transactions are updated together in one atomic transaction. Optionally, both the sets of transactions associated with the asset and the set of transactions associated first owner are created upon submission of the first ownership update transaction 702.

Next, second update ownership transaction 712 represents the ownership of the asset being transferred from the first owner to the second owner. This transaction 712 is based on data indicating which owner is losing ownership and which owner is gaining ownership (optionally, this can also be done in percentages if for example the first owner wanted to transfer 50% of the ownership to the second owner). As can be seen, the transactions 702, 712 are atomic such that all of the sets of transactions representing each asset and owner 740, 742, 748 are updated at the same time. This is due to the technical features of blockchain transactions and in particular not allowing transactions to be modified even by a malicious node in the blockchain network. To modify a transaction (by, for example, removing any data based on the second owner) would make it invalid and therefore not be able to be stored on the blockchain.

Once a transaction has been committed to the blockchain, it can be considered immutably part of the sets of transactions it references. To continue this example of FIG. 6A, once the ownership update transaction has been committed to the blockchain (via the transaction being successfully mined into a block), it will immutably belong to the set of transactions associated with the asset, the set of transactions associated with the first owner, and the set of transactions associated with the second owner. This applies similarly to other event transactions described herein including the asset user event transaction of FIG. 6B and the event interaction transaction of FIG. 6C.

Optionally, after the transaction has been submitted to the blockchain, an indication that it has been successfully mined into a block is received. This indicates, as mentioned above, the transaction is now immutably included into the set of transactions associated with the asset and any other users, owners, or clients involved with the event. With this indication, an off-chain representation of this event is updated to confirm that the event has been successfully recorded onto the blockchain and that the event is immutably associated with the appropriate sets of transactions.

FIG. 6B shows a method 610 where an event occurs between a user and an asset. This interaction could be the user using the asset.

First, a request to record an event associated with the asset and the user is received 612. The asset event request 612 comprises data to identify the associated asset and the associated user. The asset user event request preferably further comprises data relating to the event. For example, if the event is the user using the asset for 30 minutes, then the asset event request further comprises data to indicate that the asset was used for 30 minutes.

Next, an asset user event transaction is generated 614 that is based on data indicative of the asset and of the user. The asset event transaction is generated 614 based on the received asset event request. Preferably the asset user event transaction belongs to the set of transactions associated with the asset 740 and the set of transactions associated with the user 744.

As with the update ownership method 600 described above, the data indicative of the asset is preferably used to associate the transaction with set of transactions associated with the asset 740. This applies similarly to the data relating to the first user and the set of transactions associated with the first user 744.

The asset user event transaction is submitted 616 to the blockchain.

Referring to FIG. 7, the asset user event transactions 704, 706, 708, 710, 714, 716, 718, 720, 722 are shown. In these asset user event transactions, the asset is being used by the first and second users as evidenced by these asset user event transactions belonging to either both the set of transactions associated with the asset 740 and the set of transactions associated with the first user 744 or the set of transactions associated with the asset 740 and the set of transactions associated with the second user 746. Preferably, these asset user event transactions further comprise information about the event.

Referring to FIG. 6C, a method 620 is shown relating to processing an event interaction request. This method 620 may be seen as an abstracted version of the methods 600, 610 described in FIGS. 6A and 6B.

First, an event interaction request is received 622. The event interaction request comprises information to identify the asset being interacted with, which owners or users are interacting with the asset, and the type of interaction (which could be, as discussed above in the examples provided in FIGS. 6A and 6B, using the asset or transferring ownership of the asset).

Next, data indicative of the owners or users (herein, optionally described as “clients”) associated with the event is obtained 628. Preferably, the clients associated with the event are identified based on the received event interaction request and the set of transactions associated with each client is identified. Additionally or alternatively, the clients associated with the event are identified based on where the request has been sent from. Here, the data indicative of the client associated with the event is or comprises a reference to a set of transactions associated with the clients.

Preferably references to transactions are or comprise references to data stored on transaction and/or a transaction outpoint (where a transaction outpoint is a transaction id and an output index) associated with the appropriate set of transactions. More preferably, a first reference to the set of transactions associated with the client is a transaction outpoint of a next transaction in the set of transactions associated with the appropriate client. Yet still more preferably, a second reference to a latest transaction in the set of transactions associated with the appropriate client is based on data stored on the latest transaction.

Additionally or alternatively, the data indicative of the clients associated with the event is already present in the event interaction request. Additionally or alternatively, where the request comprises one or more event stream identifiers, the clients associated with the event are determined based on the one or more event stream identifier.

A “latest transaction” or “latest transaction in a set of transactions” preferably refers to the transaction immediately preceding the transaction currently being generated and/or submitted. Optionally, where all events are to be recorded on the blockchain, latest transaction refers to the transaction representing the event preceding the current event being represented on-chain.

Preferably, a reference to the set of transactions associated with the asset is similarly obtained as with the clients.

Next, an event interaction transaction is generated 624. The event interaction transaction is based on data indicative of which clients are involved with the event and data indicative of the event. Preferably, the event interaction transaction comprises representative event data which is based on the clients that are involved with the event such that the event interaction transaction belongs to, or is associated with, each set of transactions associated with the clients which are involved with the event.

Finally, the event interaction transaction is submitted 626 to the blockchain.

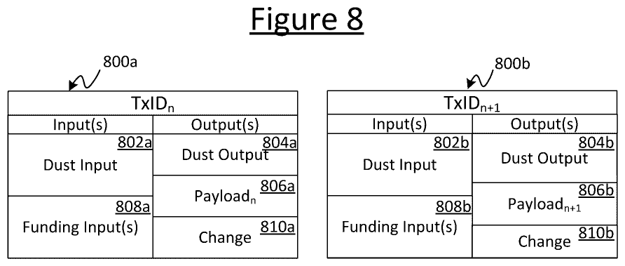

Referring to FIG. 8, an embodiment is shown of how the sets of transactions are constructed and/or defined. Preferably, the set of transactions are defined such that there is a spending relationship between at least a subset of the transactions in each set. More preferably, as each of the events have an associated order/time in which they occurred, the spending relationship between the transactions associated with each event is constructed such that a transaction 800a representing an earlier (in time) event comprises an output 804a that a transaction 800b representing the next event spends on one of its inputs 802b. Thus, a set of transactions can be seen as a chain of transactions, each representing an event.

Preferably these inputs 802a,b and outputs 804a,b that define the spending relationship in the set of transactions are spending “dust”. A dust output is associated with a (digital asset) value that is below a defined limit for a transaction or having a defined minimum value.

The use of this chain of inputs/outputs in the transactions is advantageous and key for maintaining an immutable sequential record of all transactions as they occur for an ordered, append-only event log (and in particular for an Event Stream as described below). This is because, although by posting transactions to the blockchain all blockchain transactions would be time-stamped and remain in a particular order once they are confirmed on or added to the blockchain, this does not guarantee preservation of their sequential order. This is because transactions might be mined into blocks at different times and/or the transactions are in a different order even within the same block. The use of dust outputs that are spent by the first input of the next transaction in the sequence advantageously ensures that the order of the transaction is chronologically tracked and a tamper-proof record of both the events themselves and the sequential ordering of the events is created. This is because once mined into a block, the payment of dust from a previous transaction to a next one in the sequence ensures that, in alignment with Bitcoin protocol rules, the sequence of embedded data carrier elements, called payloads and discussed below, cannot be reordered, and no insertions or deletions may occur, which could change it without it being immediately obvious that the event stream has been compromised. In some embodiments, a double spend prevention mechanism inherent to the Bitcoin protocol ensures that the movement of cryptocurrency (e.g. dust) between different transaction inputs and outputs remains in topological order. The chaining of dust transactions takes advantage of the topological ordering to provide inter and intra block transaction (and therefore associated events and data) order preservation. Thus, this improves the integrity of the sets of transactions and the data associated with them.

Optionally, the set of transactions is also additionally or alternatively based on a second reference type. Data based on this second reference type may be stored on an output of one of the transactions and the reference may refer to a preceding transaction in the set of transactions or optionally a next transaction. A reference that doesn't involve spending any outputs avoids reaching the ancestor limit of the blockchain. Preferably, this second, non-spending reference is used between subsets of transactions that do have a spending relationship between them. Optionally, the second reference is either a transaction id of a transaction in the same set of transactions or the second reference is the set of outpoint(s) that one of the transactions in the same set of transactions spends or will spend. Further details on such references are discussed in UK Patent Application No. 2102314.8 (filed in the name of nChain Holdings Limited on 18 Feb. 2021). These references are described as Change-out and Change-in references/transactions in said UK Patent Application. Further details on such referenced are also discussed in UK Patent Application No. 2204293.1 (filed in the name of nChain Holdings Limited on 25 Mar. 2022).

Optionally, the set of transactions is additionally or alternatively defined by a third reference type. This reference type preferably refers to the event and/or transaction immediately preceding it. This reference comprises or is a hash of a part of the preceding event and/or transaction. Preferably, the reference is a hash of the event data or data section of the preceding transaction. This hash provides tamper resistance to the event stream and/or set of transactions. Where this third reference type is a hash of the event data stored on the previous transaction, any modification of previous event data would also modify the hash and thus any attempt to modify data in the past would be detected by a different hash in any future different transactions. Further details on such references are discussed in the same abovementioned UK Patent Application No. 2102314.8 (filed in the name of nChain Holdings Limited on 18 Feb. 2021). These references are described as the third backward reference with reference to FIG. 6A in said UK Patent Application. Further details on such referenced are also discussed in UK Patent Application No. 2204293.1 (filed in the name of nChain Holdings Limited on 25 Mar. 2022). These references

An exception to the spending relationships with the set of transactions as discussed above are for the first and last transactions of a set of transactions. The first transaction, which as discussed above, optionally comprises information to identify what the set of transactions is associated with, does not spend a transaction from a previous event, as there will be no previous events. Similarly, the final transaction in the set of transactions is not spent by any other transactions as there are no further events to spend it.

Each event transaction preferably comprises a payload 806a,b. The payload, as described above, comprises the OP_RETURN code (and optionally an OP_0 code) to make it unspendable and allow the transaction to store data.

There may also be other inputs associated with digital assets based on an operational float. This float may be controlled by the platform processor. It is also possible to have other outputs in the transaction that are digital asset change outputs. Preferably, the event transactions 800a,b further comprise funding inputs 808a,b and change outputs 810a,b. The total value of the funding input(s) is selected to cover the transaction fee (sometimes called the miner's fee) to help ensure miners will pick up the transaction and include it in a block. A funding service may provide one or more input(s) to ensure the total value is the input(s) is sufficient. The transaction fee is dynamic and will depend on the load of the network. The transaction fee can be measured in satoshis (or whatever coin/token the blockchain system uses) per byte (where a satoshi is one hundred millionth of a single Bitcoin). Therefore, if the payload is large, the fee will also need to be large and the funding input(s) will be adjusted accordingly. As a result of the UTXO model, the total fee(s) paid are controlled by the values of both the UTXO referenced in the input and the UTXO on the output. The change left over from covering the transaction fee is optionally sent back to the same computing device managing, creating, and submitting these transactions to the blockchain. The funding inputs and change resulting from said funding inputs operates as a float and managed by said funding service.

A skilled person will appreciate that the chain of dust construction provides backward references between transactions such that a party with access to the blockchain can traverse these any sets of transactions forwards or backwards. Advantageously, this traversal can occur without any information other than what is present on the blockchain.

Traversal forwards from a given transaction is conducted by determining which output index will be spent by the next transaction (the zero-th output for example in FIGS. 8 and 9). Preferably the systems and method consistently use the same output index for all sets of transactions, or at least that the output index can be determined prior to traversal. Thus the outpoint to be spent is constructed by taking the given transaction's id and the index. The blockchain is searched to locate the transactions that spends this outpoint in one of its inputs. The process is repeated until a final transaction is located, the outpoint cannot be located and therefore the traversal has located the latest event transaction, and/or the traverser has reached the transaction they were looking for.

Traversal backwards from a given transaction works similarly. An outpoint is obtained from a determined input (the zero-th input for example in FIGS. 8 and 9). The previous transaction to traverse to will have the transaction id of the outpoint. The blockchain is then searched for a transaction with that id. The process is then repeated until the start of the set of transactions is reached and/or the traverser has reached the transaction they were looking for.

The relevant outpoint in the chain of dust for adding new transactions/events to the set of transactions is usually an outpoint of the latest transaction in the set of transactions. Preferably, the device generating the transaction for the new event will be the same device that generated the previous event transaction and so will have the outpoint already stored from this. Alternatively, the chain of dust is traversed to the latest transaction, then the transaction id and the index of the dust output are used to generate the relevant outpoint.

Referring to FIG. 9, an embodiment is shown of how transactions are constructed and/or defined such that they belong or are associated with multiple sets of transactions. Here, three sets of transactions L, M, and N are shown with one multi-set transaction 902 that is comprised in (or associated with) all three sets of transactions L, M, N. Three sets are provided by way of example only. A person skilled in the art will appreciate that different numbers of sets of transactions could be used also with only minor modification of the data structure presented. Three chains of dust are shown labelled A, B, and C and where, except for the multi-set transaction 902, the zeroth input (labelled 0) is the dust input and the zeroth output (labelled 0) is the dust output as described with reference to FIG. 8. The first output (labelled 1) of the transactions (except for the multi-set transaction 902) comprises the payload. Funding inputs and outputs can also be seen labelled with “float” in and “change” out. A skilled person will appreciate that the order of these inputs and outputs are by way of example only, other orders may be used.

The multi-set transaction 902 is shown as being a part of all of the three chains of dust A, B, C and as such said transaction 902 is considered part of (or associated with) each set of transactions L, M, N. The multi-set transaction 902 can also be described as an “atomic transaction” or a “rendezvous transaction”.

To continue the transfer of asset ownership example as described in the method 600 of FIGS. 6A and 7, the first set of transactions L is associated with the asset, the second set of transactions M is associated with the first owner, and the third set of transactions N is associated with the second owner. The multi-set transaction 902 here in this example is the same as the ownership update transaction 712 as described above. The asset ownership transaction then can be seen to comprise data indicative of the asset, data indicative of the first owner, and data indicative of the second owner. This data may be comprised in the payload, or alternatively this data is comprised in the spending relationships of the ownership update transaction i.e. given the ownership update transaction is spending an output from the set of transactions associated with each of the asset, first owner, and second owner.

Thus the atomic or rendezvous blockchain transactions are transactions across a plurality of M sets of transactions, where each set of transactions is associated with an owner, user, asset, or other. The atomic transaction involves constructing multiple dust chains, each respective to a given set of transactions among the plurality M as the first inputs. Thus the atomic transaction comprises:
n=M inputs, each input associated with a respective set of transactions among the plurality, each nth input spending a dust output associated with the previous transaction TXn−1 of the respective set of transactions,
for each of the n inputs, a respective unspent transaction output (UTXOn_dust) being an nth dust output for the atomic transaction TXn associated with the respective set of transactions, and
an unspent transaction output (UTXOn_data) associated with event data representing the current event, i.e. the data carrier.

There may be additional inputs, such as fund inputs to cover network mining fees as appropriate, and there also may be other outputs, such as change outputs or data carrier outputs such as OP_RETURN associated with each event stream for the atomic transaction.

As described above, the dust inputs and outputs, are used to prevent reordering of entries in the log, prevent after-the-fact of insertion/deletion, forks, i.e. alternative timelines, etc. leveraging the blockchain network's security, immutability, and double-spend prevention. This chain of dust formed by the nth input/output pair on a series of data carrier transactions collectively secure a respective single set of transactions (or preferably, respective single event stream ESn).

Further details of Rendezvous Transactions (in particular Rendezvous Transactions in the context of Event Streams) are discussed in UK Patent Application No. 2020279.2 (filed in the name of nChain Holdings Limited on 21 Dec. 2020).

Referring to FIGS. 10A and 10B, transactions 1022, 1026a, 1028a and a data structure 1000 are shown. The transactions and data structure set out an additional or alternative example way of constructing and/or defining sets of transactions.

Preferably, the data structure 1000 is a Merkle tree or other similar cryptographic data structure. The data structure comprises a root ‘S’ 1008, intermediate nodes, leaf nodes, and data the leaf nodes are based on 1002, 1004, 1006. The root S can be described as a “State Digest” as it can represent a digest of the current state of an event stream.

The leaf nodes are generated based on their respective inputs. Preferably, the leaf nodes are based on hashing their respective input data twice 1010, represented with H²( ) in the diagram. In the present example, the leaf nodes are based on PREV 1002, H_{D}′ 1004, and NEXT 1006. This example Merkle tree is constructed as a binary tree where each node has two children (except for the leaves). As there are an odd number of input data items (and thus odd number of leaves), the last unpaired leaf node is doubled. A person skilled in the art will appreciate that the strict adherence to this presented form of the Merkle tree is not necessary and there are other forms that may also work.

In a preferable embodiment, the Merkle tree is based on the previous transaction reference (PREV), the next transaction reference (NEXT), and a state client data digest (H_{D}′).

Optionally, the state client data digest (H′) is based on a hash of the event data received (H_{Dn}) and optionally any metadata associated with the event and/or event stream.

Preferably, the state client data digest is a Merkle tree root of a Merkle tree comprising a hash of the event data received (H_{Dn}) and any further metadata. Preferably, the signature(s) of any parties involved in the interaction this event relates to is stored in the associated state client data digest Merkle tree.

Thus, the state digest (S) can be described (with the example previous transaction reference, state client data digest (H′), and next transaction reference) according to the following formula:

$$S := Merklize ( \{ PREV , {H}_{D}^{′} , NEXT \} )$$

Where the “Merklize” function generates a Merkle root from an ordered set of data elements as leaves, and where {PREV, H_{D}′, NEXT} is an ordered set of leaves based on the elements. Each of the leaves are initially double hashed in the Merklize function. Of note, because of how hashing and Merkle trees work, the order of the set of inputs to it matters, thus the order of the inputs must be the same whenever a Merkle tree is created, recreated, or verified so that the same tree (and therefore same state digest) is generated for the same input data.

Optionally each of {PREV, H_{D}′, NEXT} are salted. Optionally the salting is conducted by prepending a salt before hashing each item.

Alternative to the Merkle tree structure, the state digest can be generated by hashing a preimage where the preimage is constructed by concatenating the objects the state data is based on. Thus, in an example where the state digest is based on the previous transaction reference, the state client data digest, and the next transaction reference, a formula could be of the form:

$$S := H ( PREV ‖ {H}_{D}^{′} ‖ NEXT )$$

Optionally, a salt may be incorporated to the preimage also. For example, the salt may be concatenated at the beginning or the end of the preimage.

As a further alternative to the Merkle tree root, the state digest can be generated by using a hash chain. A hash chain is constructed such that each intermediate hash result is prepended with an item the state digest is based on. For example, where the state digest is based on the previous transaction reference, the state client data digest (H_{D}′), and the next transaction reference, a formula could be of the form:

$$S := H ( PREV ‖ H ( {H}_{D}^{′} ‖ H ( NEXT ) ) )$$

Optionally, a salt is incorporated into the hash chain. Optionally, the salt is incorporated by prepending the salt to each intermediate preimage.

Alternative to the Merkle tree structure, all of the PREV, NEXT, and H_{D}′ (or H_{D}) are stored on the blockchain without being hashed or processed.

### Previous Transaction Reference (PREV)

As discussed above, the state digest is preferably based on a reference to a previous transaction. Preferably, the reference to the previous transaction in the set of transactions is based on the state data of said previous transaction being referenced. More preferably, the reference to the previous transaction is the state data of said previous transaction being referenced as it is stored on the blockchain. The previous transaction reference is optionally called a parent transaction reference and the current transaction is its child.

### Next Transaction Reference (NEXT)

As discussed above, the state digest is preferably based on a reference to a next transaction. Preferably, the reference to the next transaction in the set of transactions is based on an input to the next transaction. Advantageously, while many of the components of the next transaction are not known (as a result of its existence being in the future and based on data submitted by a client) and therefore said unknown components cannot be used as a reference, the input UTXO or UTXOs used for funding a transaction can be determined in advance and will be unique to only that transaction when it is committed to the blockchain. Preferably, the input UTXO(s) are referenced by an outpoint. An outpoint comprises the transaction id of the transaction the UTXO belongs to (called TxD), and the index of the output on said referenced transaction (called vout). The next transaction reference is optionally called a child transaction reference and the current transaction is the parent.

Referring to FIG. 10B, three example transactions 1022, 1026a, 1028a of a set of transactions are shown. The transaction TxIDn 1022 comprises a funding input 1038 and a data payload 1024a, where the data payload comprises the data digest (H_{Dn}) and state digest (Sn) 1030a and the state digest is a Merkle tree root of a tree based on a reference 1032a to the previous transaction 1026a, state client data digest (H_{D}′) 1036a, and a reference 1034a to the next transaction 1028a. It can be seen that the state client data digest (H_{D}′) 1036a is a Merkle tree root of a Merkle tree based on the data digest (HDn), a salt (SALT), the TxD of the first transaction in the chain of commitments (TxIDcreate) (this being example metadata of the event, event stream and/or set of transactions) and other metadata as signified by the ‘ . . . ’.

The reference to the previous transaction 1032a is the state digest (S) of the previous transaction 1026a. The reference to the next transaction 1034a is the outpoint of the funding input to the next transaction 1028a.

Thus, the current transaction 1022 can be seen to comprise the state digest (S). Optionally the transaction also comprises a hash of the event data H_{Dn}. Thus, it can be seen that the transaction and/or data comprised in the transaction is based on at least the event data, reference to a previous transaction in the set of transactions, and a reference to a next transaction in the set of transactions.

The transaction TxIDn of FIG. 10B is presented as an example only. A skilled person will appreciate that only one reference is required to establish a set of associated transactions (either forward or back). A skilled person will also appreciate that the hash of the client data is optionally stored on the payload of transaction TxIDn.

Referring to FIG. 10C, an embodiment is shown of how transactions are constructed and/or defined such that they belong or are associated with multiple sets of transactions 1040. Here, three sets of transactions n1, n2, and nk are shown with one multi-set transaction 1042 that is comprised in (or associated with) all three sets of transactions n1, n2, nk. Three sets are provided by way of example only. A person skilled in the art will appreciate that different numbers of sets of transactions could be used also with only minor modification of the data structure presented.

The multi-set transaction 1042 is shown as being a part of all of the three sets of transactions n1, n2, nk. The multi-set transaction 1042 can also be described as an “atomic transaction” or a “rendezvous transaction”.

It can be seen that one output 1044, 1046, 1048 is used per set of transactions the Rendezvous transaction is a part of. For example, if the Rendezvous transaction is a part of three sets of transactions, the Rendezvous transaction comprises three outputs. Each transaction output comprises a payload that relates to a respective set of transactions.

Preferably each output 1044, 1046, 1048 of the rendezvous transaction is of the same form as described above with reference to a non-rendezvous transaction as described with reference to FIGS. 10A and 10B in that the output comprises a data digest and a state digest (S) (the state digest being based on a reference to the previous and next transactions in the chain, as well as a state client data).

Each output 1044, 1046, 1048 of the rendezvous transaction also has a corresponding funding input. Optionally, this funding input is of the same form and amount as with a non-rendezvous transaction as described with reference to FIGS. 10A and 10B. Advantageously, by using the same UTXO fund input referencing method, a non-rendezvous transaction can still reference a rendezvous transaction in the next transaction reference without any further modification (as the rendezvous transaction will still have a funding input to reference). Similarly, the rendezvous transaction still comprises a state digest (S) on each output such that a next transaction in the chain of commitments referencing a rendezvous transaction can still use the same preferred previous transaction reference.

Thus, as can be seen in the figure, each rendezvous transaction output 1044, 1046, 1048 is based on a reference to its corresponding previous non-rendezvous transaction 1050, 1052, 1054 through use of the state digest (Sn1−1, Sn2−1, Snk−1). Also it can be seen that each rendezvous transaction output is based on a reference to its corresponding next non-rendezvous transaction 1056, 1058, 1060 using the funding input reference of the next non-rendezvous transaction reference (On1+1, On2+1, Onk+1).

Advantageously, by using the same UTXO fund input referencing method, a non-rendezvous transaction can still reference a rendezvous transaction in the next transaction reference without any further modification (as the rendezvous transaction will still have a funding input to reference). Similarly, the rendezvous transaction still comprises a state digest (S) on each output such that a next transaction in the chain of commitments referencing a rendezvous transaction can still use the same preferred previous transaction reference.

Referring to FIG. 10D, an alternative method of constructing a rendezvous transaction is shown. Here, instead of a different input and output per chain of commitments that TxIDi belongs to (as shown in FIG. 10C), a single transaction input and output is used.

The Data Digest (HD) of TxIDi is instead based on all of the client data D submitted across all of the different chains. Preferably, Data Digest is a Merkle tree root, wherein the Merkle tree is generated each leaf node is based on the client submitted data of each chain.

Preferably, a hash of each client data is used. This way, the size of the Data Digest is as stored on the blockchain remains the same irrespective of the number of the chain of commitments the transaction TxIDi is a part of.

Similarly, the State Digest is based on all of the previous transaction references as well as all of the next transaction references. Instead of a Merkle tree comprising only PREV, HD, and NEXT as preimages to the leaf nodes, all of PREV references across the different chain of commitments, all of the HDs across the different chain of commitments, and all of the NEXT references across all of the different chain of commitments are leaf nodes. This provides similar advantages that the single output of TxIDi does not increase in size, even though it is based on a potentially substantially larger amount of data.

Alternative to the Merkle trees as described in the previous two paragraphs, all of the received client data across the different chain of commitments are concatenated and hashed to give a final Data Digest and all of the PREVs, HDs, and NEXTs across all the different chain of commitments are concatenated and hashed to give a final State Digest.

To continue the transfer of asset ownership example as described in the method 600 of FIGS. 6A and 7, the first set of transactions n1 is associated with the asset, the second set of transactions n2 is associated with the first owner, and the third set of transactions nk is associated with the second owner. The multi-set transaction 1042 here in this example is the same as the ownership update transaction 712 as described above. The asset ownership transaction then can be seen to comprise data based on data indicative of the asset, data indicative of the first owner, and data indicative of the second owner.

Further details on such the data structures and transaction layouts of FIGS. 10A-10D are discussed in UK Patent Application No. 2204293.1 (filed in the name of nChain Holdings Limited on 25 Mar. 2022).

With the Merkle tree root stored on the blockchain, Merkle tree proofs can then be used to prove that certain data was used in the construction of the Merkle tree associated with the Merkle tree root.

Preferably, the platform processor (or other device with access to the data used to construct the original Merkle tree) is configured, upon reception of a verification request, to provide a verification response wherein the verification response comprises a Merkle tree proof. More preferably, the verification request comprises a label of the data to be verified and the verification response comprises event data and/or data associated with the event based on the label of the data to be verified, and a Merkle tree proof configured to prove that said event data and/or data associated with the event was used in the construction of the Merkle tree associated with the Merkle tree root stored on the blockchain. Alternatively, the verification response comprises all of the data used to construct the Merkle tree and the receiver of the verification response constructs the Merkle tree themselves to obtain a matching Merkle tree root (only matching if it is valid). Of note, as H_{D}′ (which is used in the creation of the Merkle tree comprising the root S) is also a Merkle tree root, Merkle tree proofs can be generated such that any arbitrary data of the Merkle tree can be proved to have been part of the original Merkle tree root created. For example, a third party may wish to access metadata associated with an event, but not the event data itself. A Merkle tree proof can be constructed such that only the requested metadata is revealed and not any other features used to construct the Merkle tree.

Advantageously, having the ability to selectively disclose parts of the Merkle tree enables, among other things, sellers of assets to allow buyers to interrogate certain features of the asset or assets they are wanting to purchase without confidential information being disclosed to the buyer. The amount of information to be disclosed is configurable by the owner of the asset (or controller of the event stream associated with the asset) by selecting what is comprised in a Merkle tree proof.

An example mechanism for implementing such selective disclosures in a blockchain is set out in UK patent application number 2206682.3 filed on 6 May 2022 by nChain Holdings Limited.

By storing only a Merkle tree root which is based on the event data and/or at least one reference (and preferably two reference), a number of advantages can be seen. In particular, the Merkle tree root can act as a proof of existence of the event data without having to store the event data on the blockchain itself thereby saving space on the blockchain. Further, using a Merkle tree root, which has a known size, enables the size of the overall transaction to be known and constant, thereby making the funding of the transactions being stored on the blockchain to be simplified. Further still, by storing only the Merkle tree root on the blockchain, malicious third parties cannot inspect the set of transactions without further information (such as a Merkle tree proof). On-chain, a Merkle tree root looks like any other piece of hashed data and therefore the rate of transactions being added to the set of transactions, among other features, is hidden thereby increasing security of the data stored.

Optionally, both of the transaction set referencing examples of FIGS. 8 and 9 and the transaction set referencing examples of FIGS. 10A-10C are used together. In this embodiment, some references may be constructed through use of a spending relationship and other references may be constructed through the use of a Merkle tree comprising data indicative of a previous and/or next transaction. For example, the asset set of transactions are maintained through use of the chain of spending relationships and other user's interactions and sundry data are maintained through the Merkle tree data structure. This particular example could be advantageous as the number of interactions with the asset is publicly accessible, however what those interactions are (whether they be usages, ownership transfer, or other) are hidden.

Preferably, the transactions generated 604, 614, 624 and submitted 606, 616, 626 in the embodiments as described with reference to FIGS. 6A-6C are of the above described “rendezvous transaction” form as described with reference to FIG. 9 and/or FIGS. 10C and 10D.

Where the blockchain is not a UTXO based system (could be an account-based system such as what is used with Ethereum), alternative ways to associate transactions atomically/synchronously may also be used. For example, a smart contract on the Ethereum blockchain with permission to spend from a wallet associated with an asset and any other clients (such as the owner(s) or users) may be established such that, when a client or clients interact(s) with the asset, a transaction is created such that it spends from a first address associated with the asset to a second address associated with the asset and similarly for any client(s) interacting with the asset. Where possible, a single transaction is generated that spends asset of the asset and client(s) spending in a single transaction or another atomic mechanism may also be used.

These wallet addresses are optionally deterministically determined. Optionally the wallets are generated according to BIP-32 or BIP-44 or other appropriate hierarchical deterministic method.

With deterministically generated addresses for a wallet, the set of transactions associated with, for example, the asset, can be determined by determining a list of possible wallet addresses, and then scanning the blockchain for any transactions that send to or from any of the determined possible wallet addresses. This hierarchical deterministic wallet arrangement could also be used with the UTXO model. Advantageously, this arrangement could introduce further privacy to a client's associated set of transactions as it would be harder to determine that it is the same entity sending as is receiving since the public keys and signatures are different for different keys.

### Event Streams

In the present embodiment, the set of transactions which are associated with the different owner(s), user(s), asset(s), or other are used to represent an event stream. Event Streams ES preferably being specific to a smart contract SC, and representing the states of the smart contract SC (thus, each of the asset, owner(s), and user(s) are all tracked with a smart contract). An example mechanism for implementing an event stream in a blockchain is set out in UK patent application number 2002285.1 filed on 19th February 2020 by nChain Holdings Limited. An event stream provides a log of the exact sequence of events executed in order and is implemented on the blockchain. The event stream ES that pertains to the smart contract SC may be obtained directly from the blockchain, or this may be obtained from an off-chain log or database that replicates the event stream on the blockchain. For example, a platform processor (or other device) may be associated with a snapshot instance database that is configured to provide or indicate the present state of smart contract SC, as recorded in the respective event stream ES in the blockchain at any given time. There will only be one event stream per smart contract that is associated with a given client among a plurality of clients. In some embodiments, each client among a plurality may be associated with an account or identifier which may be used to identify a particular smart contract SC that is associated with the respective client.

In some embodiments, there may be one smart contract that is associated with multiple event streams. Optionally, one smart contract updates multiple different event streams where each event stream still represents a different asset, user, owner, or client.

As mentioned above, in some embodiments, the event stream relates to a state machine, and represents a machine-readable contract or smart contract that is implemented as a finite state machine in the blockchain. A Finite state Machine (FSM) is a well-known mathematical model of computation. It is an abstract machine that can be in exactly one of a finite number of states at any given time. The FSM can change from one state to another in response to some external inputs—the change from one state to another is called a transition. An FSM may be defined by a list of its states, its initial state, and the conditions for each transition. In the Bitcoin SV Blockchain the UTXO set can be thought of as a state machine, with a given output's spent state being a function of previous inputs to the transaction (the machine). Thus, by replaying all transactions, the current spend state of any output, and the current contents of the UTXO set, can be established deterministically using the blockchain. Thus, in some embodiments, the request can be considered as a request to alter a current state of a smart contract, implemented as an event stream ES in the blockchain.

Techniques for establishing an immutable sequential log or record of the event stream ES (or just a set of transactions generally) up to its current state on the blockchain have been described herein. In some embodiments, the log (in addition to being stored on the blockchain) can also be provided or stored off-chain as mentioned above. The event stream may represent sequential inputs that are applied to a smart contract that is implemented using an FSM, DFA etc.

Advantageously, the implementation of an event stream and its set of transactions associated with the blockchain as implemented by the methods of the present disclosure offers guarantees relating to immutability of events and immutability of event sequencing.

Once written, any attempt to tamper with the event stream in any of the following ways is either prevented or made evident:
Changing the contents of an event
Re-ordering events
Inserting events at the start or middle of a stream
Removing events from anywhere in the stream

In other words, the methods described herein make the following attributes relating to the event stream provable:
Individual entries in the event stream have not been modified since they were written
No entries have been inserted between previously contiguous entries
No entries have been removed
No entries have been re-ordered

These properties and advantages have many practical applications, from audit/compliance logs, to state machine replication, to more efficient, tamper resistant and accurate methods for reading from and writing data into the blockchain for all clients.

### Example Use Case

An example usage of the methods and systems described herein are to track ownership and usage of a pay-per-use non-fungible good, product, or service. For a specific example, the asset is a music track or song in the context of a pay-per-listen music streaming model. The music track of this example is equivalent to the asset of the aspects described herein.

In the present example, when a user listens to a song, an asset interaction request is provided to the platform processor. The platform processor then undertakes the method 610 as described in FIG. 6B and submits a transaction to the blockchain that represents this listening event. The transaction optionally comprises the number of times the song was listened to, or the transaction optionally comprises data based on the number of times the song was listened to. Preferably, the transaction belongs to the set of transactions associated with the music track and to the set of transactions associated with the listener. An effect of this transaction is to represent that this specific listener has listened to this specific song—and this information is present in both the sets of transactions associated with the song and the user.

Similarly, the ownership of the music track can be changed using the method 600 as described with reference to FIG. 6A. In this case, a transaction that is associated with the set of transactions associated with the asset, first owner, and second owner is generated and submitted to the blockchain.

Preferably, the set of transactions associated with the music track comprises a transaction comprising data (or is based on data) which is able to identify the song uniquely. Preferably, the data to identify the song is a digital fingerprint.

Advantageously, the methods and systems described herein being used in this example enable a prospective purchaser of the rights to the music track can verify the revenue history from since the song has been tracked using the blockchain. This enables the potential purchaser to fairly assess the value of the music track.

Advantageously, the listener/user can verify their full listening information and history so that they can verify their billing history.

Advantageously, a song owner can be sure of the revenue generated by the song.

The advantages provided above apply equally to any other pay-per-use non-fungible good, product, or service.

### Platform Services

According to an aspect, any one or more of the preceding aspects related asset interaction tracking and/or sets of transactions may be used with a platform processor as described here. Preferably, the platform processor is configured to receive asset interaction information and to provide data services 1502, compute services 1504, and/or commerce services 1506 access through which is provided by the API 1508. In particular, the data service 1502 aspects are provided for storage of event data. The present aspect may be Platform as a Service (PaaS) and Software as a Service (SaaS) offering that advantageously enables rapid delivery of useful real-world business and technical applications, such as management of software controlled technical systems or smart contracts, using a blockchain network such as the BSV blockchain.

An overview of the platform services can be seen in FIG. 11 that shows a high-level schematic of the system. The platform service has a platform processor 1500 that provides an API 1508, via which the services may be accessed by one or more clients.

Platform Services 1500 as shown in this FIG. 11 are made up of three families of services and is aimed at allowing users and organisations to easily and securely make use of the advantages offered by the unique properties of a blockchain, without actually implementing any blockchain based software, knowledge, or libraries at the client end. These services are:
Data Services 1502 that aim to simplify the usage of the chain as a commodity data ledger. The Data Services preferably use the data structures and methods provided herein for implementing data writing to and reading from the blockchain.
Compute Services 1504 that aim to provide a generalised compute framework backed by a digital asset such as Bitcoin SV.
Commerce Services 1506 that provide enterprise-class capabilities for transacting using a digital asset such as Bitcoin SV.

Requests may be received via or using the HTTPS protocol from a client at the API, as the API is implemented as a web service. The requested services are then implemented by the one or more service modules or processing resources 1502-1506 using underlying software 1510, such underlying software 1510 being associated with the blockchain, i.e. to implement resources, libraries and/or key-management wallet implementations for creating, processing and submitting transactions associated with the blockchain. Once processed, transactions can be submitted to the blockchain network 1512 (instead of the client implementing any such functionality or transaction libraries). At most, the client may or can implement a digital wallet or the like associated with cryptocurrency or some other digital asset, but this is not essential as the platform service 1500 may also be able to provide and manage the digital asset for the client.

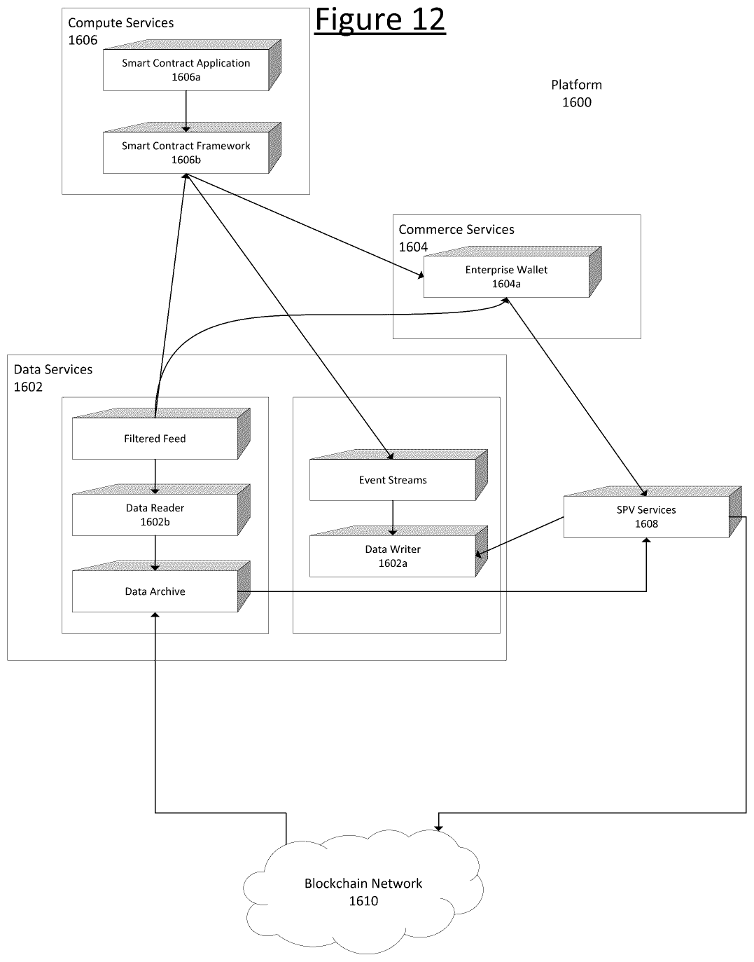

FIG. 12 provides a more granular schematic view of the plurality of services associated with a blockchain, and which can be implemented by the platform 1600 that is associated with an API via which any one or more of the offered services can be accessed. As seen in this FIG. 12, the data services 1602 may include a data writer 1602a and a data reader service 1602b. The data writer service 1602a enables clients to write data into the blockchain in a simple, secure and optimised manner. The data reader service 1602b enables the clients to send queries, which returns data that is stored in the blockchain. This may be using filtered streams in which the client may pre-define the type of data that they wish to read from the blockchain on an ad hoc or periodic basis, i.e. within a certain timeframe, or those associated with a set of related or unrelated events or documents that are processed in the blockchain 1610. The data archive feature allows access to logs of previous transaction for a specified event or contract.

The compute services 1606 of the platform 1600 includes an application 1606a and framework 1606b associated with smart contracts, which in some embodiments may be represented as a state machine in the blockchain 1610. The compute services 1606 interacts with the data services 1602 as data will need to be input and results provided to a client for any such computation.

Commerce services 1604 are responsible for provision of enterprise-class capabilities via enterprise wallets 1604a for transacting over the blockchain 1610, based on best-in-class security practices and technologies. For example, in some embodiments, enterprise wallets may implement functionality to enable blockchain transaction processing when more than one person, user, or account may need to sign off on a transaction meeting a defined criterion. i.e. associated with cryptocurrency of a large value above a certain predefined limit.

An enterprise wallet may also include functionality to implement a threshold number and/or type of signatures to move large amounts of digital assets such as cryptocurrency or tokens representing another resource. The movement of these assets can then be represented on the blockchain following processing based on the criteria applied by such enterprise wallet implementation.

The SPV services 1608 (simplified payment verification) are applications that require information from the blockchain but do not include direct links to it, as they do not run a miner node. Such SPV service 1608 allows a lightweight client to verify that a transaction is included in a blockchain, without downloading the entire blockchain 1610.

### Platform Devices

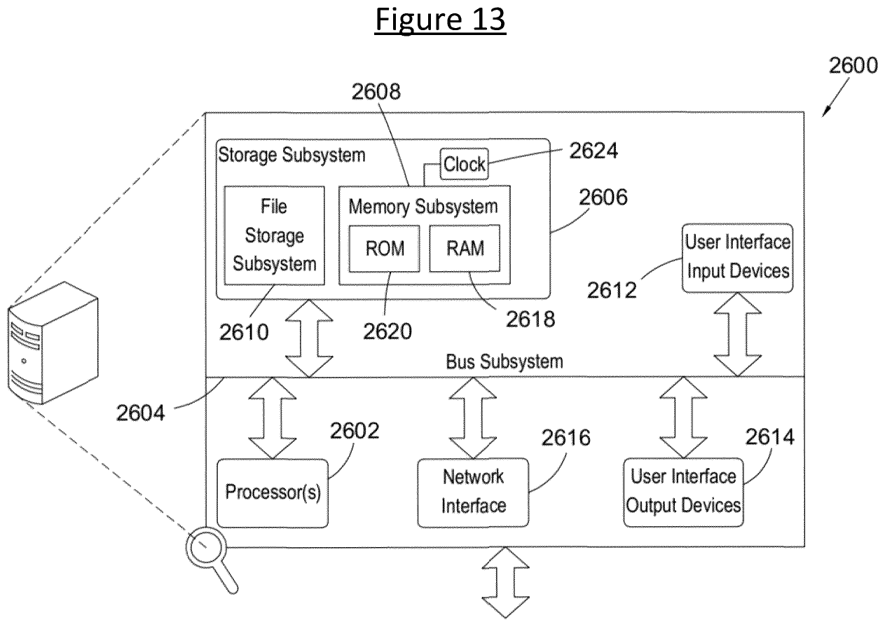

Turning now to FIG. 13, there is provided an illustrative, simplified block diagram of a computing device 2600 that may be used to practice at least one embodiment of the present disclosure. In various embodiments, the computing device 2600 may be used to implement any of the systems or methods illustrated and described above. For example, the computing device 2600 may be configured to be used as one or more components in the previously described system 500 of FIGS. 5. The computing device 2600 may be configured to be a client entity that is associated with a given user; the client entity making database requests and/or submissions to the platform processor. The computing device 2600 may be configured to be a delegated user. The delegated user, upon reception of their delegated authorisation token may make data requests and/or submissions to the platform processor. Thus, computing device 2600 may be a portable computing device, a personal computer, or any electronic computing device. As shown in FIG. 12, the computing device 2600 may include one or more processors with one or more levels of cache memory and a memory controller (collectively labelled 2602) that can be configured to communicate with a storage subsystem 2606 that includes main memory 2608 and persistent storage 2610. The main memory 2608 can include dynamic random-access memory (DRAM) 2618 and read-only memory (ROM) 2620 as shown. The storage subsystem 2606 and the cache memory 2602 and may be used for storage of information, such as details associated with transactions and blocks as described in the present disclosure. The processor(s) 2602 may be utilized to provide the steps or functionality of any embodiment as described in the present disclosure.

The processor(s) 2602 can also communicate with one or more user interface input devices 2612, one or more user interface output devices 2614, and a network interface subsystem 2616.

A bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilise multiple buses.

The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a network such that the data technician may be able to transmit data to the device and receive data from the device while in a remote location, such as a data centre.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600.

The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. For example, the main memory 2608 and cache memory 2602 can provide volatile storage for program and data. The persistent storage 2610 can provide persistent (non-volatile) storage for program and data and may include flash memory, one or more solid state drives, one or more magnetic hard disk drives, one or more floppy disk drives with associated removable media, one or more optical drives (e.g. CD-ROM or DVD or Blue-Ray) drive with associated removable media, and other like storage media. Such program and data can include programs for carrying out the steps of one or more embodiments as described in the present disclosure as well as data associated with transactions and blocks as described in the present disclosure.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fibre-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 13 is intended only as a specific example for purposes of illustrating the preferred embodiment of the device. Many other configurations having more or fewer components than the system depicted in FIG. 13 are possible.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” or “hardware module” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” or “hardware module” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “determining”, “providing”, “calculating”, “computing,” “identifying”, “combining”, “sending”, “receiving”, “storing”, “estimating”, “checking”, “generating” “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The singular reference of an element does not exclude the plural reference of such elements and vice-versa.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method for tracking, on a blockchain, at least two clients interacting with an asset, wherein the blockchain comprises a set of transactions associated with the asset, a first set of transactions associated with a first client of the at least two clients, and a second set of transactions associated with a second client of the at least two clients, the method comprising the steps:
receiving an asset interaction event request comprising data indicative of at least two clients associated with an asset interaction event and data indicative of the asset,
generating an event transaction based on:
at least one reference to the set of transactions associated with the asset;
at least one reference to the set of transactions associated with the first client; and
at least one reference to the set of transactions associated with the second client, and
submitting the event transaction to the blockchain.

2. The method of claim 1, wherein a first reference of the at least one reference to the set of transactions associated with the asset comprises an asset transaction outpoint associated with the set of transactions associated with the asset.

3. The method of claim 2, wherein the asset transaction outpoint points to a next transaction in the set of transactions associated with the asset.

4. The method of claim 1, wherein a second reference of the at least one reference to the set of transactions associated with the asset comprises data stored on the latest transaction in the set of transactions associated with the asset.

5. The method of claim 4, wherein the second reference of the at least one reference to the set of transactions associated with the asset is part of a data payload stored of the latest transactions in the set of transactions associated with the asset.

6. The method of claim 1, wherein each of a first of the at least one references to the sets of transactions associated with the first client and the second client comprises a transaction outpoint associated with each of the set of transactions associated with first client and the second client.

7. The method of claim 6, wherein each transaction outpoint points towards a next transaction in each respective set of transactions associated with the clients.

8. The method of claim 1, wherein the set of transactions associated with the asset pertains to an event stream associated with the asset and each set of transactions associated with a given client among the at least two clients pertains to an event stream associated with said given client.

9. The method of claim 8, wherein each event stream represents a respective smart contract such that the event stream tracks a sequence of events associated with the smart contract.

10. The method of claim 1, wherein the event transaction comprises data based on the asset interaction event.

11. The method of claim 10, wherein the data indicative of the asset interaction event is stored on an unspendable output of the event transaction.

12. The method of claim 1, wherein the asset is a song and/or the asset interaction event is to exchange ownership of the asset between the at least two clients.

13. The method of claim 1, further comprising the steps of:
obtaining a reference to the set of transactions associated with the asset, and
obtaining references to each set of transactions associated with the clients associated with the asset interaction event.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A computer-implemented method for tracking ownership and usage of an asset on a blockchain, comprising the steps:
receiving a creation request to associate an asset with a first owner on the blockchain,
receiving at least one usage message comprising data indicative of a user using the asset, and upon reception of each usage message:
submitting a usage transaction to the blockchain, the usage transaction comprising data based on the asset used and a user using the asset;
receiving an ownership update request comprising information indicative of a second owner, and upon reception of the ownership update request:
submitting an update transaction to the blockchain, the update transaction comprising information based on the asset, the first owner, and the second owner.

32. The method of claim 31, wherein the blockchain comprises any one or more of the following: a set of transaction associated with the asset, a set of transactions associated with the user, a set of transactions associated with the first owner, and a set of transactions associated with the second owner.

33. The method of claim 32, wherein the set of transactions associated with the asset is associated with a smart contract associated with the asset, the set of transactions associated with the first owner is associated with a smart contract associated with the first owner, the set of transactions associated with the second user is associated with a smart contract associated with the second user, and the set of transactions associated with the user is associated with a smart contract associated with the user.

34. The method of claim 32, wherein the set of transactions associated with the asset pertains to an event stream associated with the asset, the set of transactions associated with the user pertains to an event stream associated with the user, the set of transactions associated with the first owner pertains to an event stream associated with the first owner, and the set of transactions associated with the second owner pertains to an event stream associated with the second owner.

35. The method of claim 34, wherein each event stream represents a smart contract such that the event stream tracks a sequence of events associated with a smart contract.

36. The method of claim 32, wherein the usage transaction comprises a first data payload comprising data based on a at least one reference to the set of transactions associated with the asset and second data payload comprising data based on at least one reference to the set of transactions associated with the user.

37. The method of claim 32, wherein the set of transactions associated with the asset comprises, indicates, is based on ownership history of the asset.

38. The method of claim 32, wherein the update transaction comprises a third data payload comprising data based on a third reference to a transaction from the set of transactions associated with the asset, a fourth data payload comprising data based on a fourth reference to a transaction from the set of transactions associated with the first owner, and a fifth data payload comprising data based on a fifth reference to a transaction from the set of transactions associated with the second owner.

39. The method of claim 38, wherein, upon confirmation of the update transaction to the blockchain, ownership of the asset is considered transferred from the first owner to the second owner.

40. The method of claim 32, further comprising the steps of:
receiving a history request from a requestor comprising a reference to the asset, and in response to reception the history request:
providing a history of uses of the asset to the requestor, wherein the history of the uses of the asset comprises information from the set of transactions associated with the asset and/or is verified using information from the set of transactions associated with the asset.

41. The method of claim 31, wherein the usage message comprises data based on usage of the asset by a user and the usage transaction comprises data indicative of usage of the asset.

42. The method of claim 1, wherein the asset is a song, and the data indicative of usage comprises a number of times and/or length of time a user has listened to said song.

43. (canceled)

44. A system, comprising:
a server configured to perform a computer-implemented method for tracking ownership and usage of an asset on a blockchain, comprising the steps of:
receiving a creation request to associate an asset with a first owner on the blockchain,
receiving at least one usage message comprising data indicative of a user using the asset, and upon reception of each usage message:
submitting a usage transaction to the blockchain, the usage transaction comprising data based on the asset used and a user using the asset,
receiving an ownership update request comprising information indicative of a second owner, and upon reception of the ownership update request:
submitting an update transaction to the blockchain, the update transaction comprising information based on the asset, the first owner, and the second owner; and
a first ownership device and a second ownership device configured to coordinate transmission of an update message to the server.
